(19) United States
(12) Patent Application Publication
(10) Pub. No.: US 2026/0246974 A1
(43) Pub. Date: Aug. 20, 2026

(54) METHOD AND APPARATUS FOR DETERMINING POINT CLOUD ATTRIBUTE INFORMATION, AND ELECTRONIC DEVICE

(71) Applicant: VIVO MOBILE COMMUNICATION CO., LTD., Dongguan (CN)

(72) Inventors: Wei ZHANG, Dongguan (CN); Xiaoyu LIU, Dongguan (CN); Fuzheng YANG, Dongguan (CN); Zhuoyi LV, Dongguan (CN)

(21) Appl. No.: 19/643,849

(22) Filed: Apr. 10, 2026

Related U.S. Application Data
(63) Continuation of application No. PCT/CN2024/123300, filed on Oct. 8, 2024.

(30) Foreign Application Priority Data
Oct. 10, 2023 (CN) 202311310867.2

(51) Int. Cl. H04N 19/597; H04N 19/147; H04N 19/18; H04N 19/59; H04N 19/64

(52) U.S. Cl. CPC H04N 19/597; H04N 19/147; H04N 19/18; H04N 19/59; H04N 19/64

(57) ABSTRACT

This application discloses a method and an apparatus for determining point cloud attribute information, and an electronic device, and belongs to the technical field of attribute compression of points in a point cloud. The method for determining point cloud attribute information in the embodiments of this application includes: obtaining, by an encoding side, attribute information of a first node in a first point cloud frame; and determining, by the encoding side when it is determined that a second node in a second point cloud frame is similar to the first node, reconstructed attribute information of the second node based on the attribute information of the first node in the first point cloud frame.

### CROSS-REFERENCE TO RELATED APPLICATIONS

This application is a continuation of International Patent Application No. PCT/CN2024/123300, filed on Oct. 8, 2024, which claims priority to Chinese Patent Application No. 202311310867.2, filed on Oct. 10, 2023 in China, both of which are incorporated herein by reference in their entireties.

### TECHNICAL FIELD

This application belongs to the technical field of attribute compression of points in a point cloud, and in particular, to a method and an apparatus for determining point cloud attribute information, and an electronic device.

### BACKGROUND

In an encoder framework of geometry-based point cloud compression (Geometry-based Point Cloud Compression, G-PCC), geometry information and attribute information of a point cloud are encoded separately. Attribute coding of G-PCC may be divided into region adaptive transform and lifting transform based on hierarchical structure division.

The region adaptive transform includes: firstly, constructing a transform tree structure based on the point cloud. Starting from the bottom, an octree structure is constructed from the bottom up. In a process of constructing the transform tree, corresponding Morton code information, attribute information, and weight information need to be generated for a merged node. Then, from top to bottom, region adaptive hierarchical transform (Region Adaptive Hierarchical Transform, RAHT) is performed on original attribute values level by level from a root node, an alternating current (Alternating Current, AC) coefficient is obtained through calculation, and quantization and entropy coding are performed on the AC coefficient, to finally obtain an attribute code stream.

From the above process, it can be learned that in a point cloud coding method based on region adaptive transform in the related art, attribute information of each node in an RAHT tree needs to be calculated.

### SUMMARY

Embodiments of this application provide a method and an apparatus for determining point cloud attribute information, and an electronic device, which may reconstruct attribute information of a current node based on a similar node in another frame, without calculating and coding the attribute information of the current node with a similar node, and can reduce complexity of a point cloud coding process.

According to a first aspect, a method for determining point cloud attribute information is provided, and the method includes:
obtaining, by an encoding side, attribute information of a first node in a first point cloud frame; and
determining, by the encoding side when it is determined that a second node in a second point cloud frame is similar to the first node, reconstructed attribute information of the second node based on the attribute information of the first node in the first point cloud frame.

According to a second aspect, a method for determining point cloud attribute information is provided, and the method includes:
obtaining, by a decoding side, attribute information of a first node in a first point cloud frame; and
determining, by the decoding side in a case of decoding a target code stream of a second point cloud frame, reconstructed attribute information of a second node in the second point cloud frame based on the attribute information of the first node in the first point cloud frame, where the second node and the first node are similar nodes.

According to a third aspect, an apparatus for determining point cloud attribute information is provided, and the apparatus includes:
a first obtaining module, configured to obtain attribute information of a first node in a first point cloud frame; and
a first determining module, configured to determine, when it is determined that a second node in a second point cloud frame is similar to the first node, reconstructed attribute information of the second node based on the attribute information of the first node in the first point cloud frame.

According to a fourth aspect, an apparatus for determining point cloud attribute information is provided, and the apparatus includes:
a second obtaining module, configured to obtain attribute information of a first node in a first point cloud frame; and
a second determining module, configured to determine, in a case of decoding a target code stream of a second point cloud frame, reconstructed attribute information of a second node in the second point cloud frame based on the attribute information of the first node in the first point cloud frame, where the second node and the first node are similar nodes.

According to a fifth aspect, a terminal is provided. The terminal includes a processor and a memory, the memory stores a program or an instruction that can be run on the processor, and when the program or the instruction is executed by the processor, the steps of the method according to the first aspect or the steps of the method according to the second aspect are implemented.

According to a sixth aspect, an electronic device is provided, including a processor and a communication interface, where
when the electronic device is used as an encoding side device, the processor is configured to: obtain attribute information of a first node in a first point cloud frame; and determine, when it is determined that a second node in a second point cloud frame is similar to the first node, reconstructed attribute information of the second node based on the attribute information of the first node in the first point cloud frame;
or
when the electronic device is used as a decoding side device, the processor is configured to: obtain attribute information of a first node in a first point cloud frame; and determine, in a case of decoding a target code stream of a second point cloud frame, reconstructed attribute information of a second node in the second point cloud frame based on the attribute information of the first node in the first point cloud frame, where the second node and the first node are similar nodes.

According to a seventh aspect, an electronic device is provided, including: a memory, configured to store video data, and a processing circuit, configured to implement the steps of the method according to the first aspect, or implement the steps of the method according to the second aspect.

According to an eighth aspect, a readable storage medium is provided. The readable storage medium stores a program or an instruction, and the program or the instruction is executed by a processor to implement the steps of the method according to the first aspect or the steps of the method according to the second aspect.

According to a ninth aspect, a codec system is provided, including an encoding side device and a decoding side device. The encoding side device may be configured to perform the steps of the method according to the first aspect, and the decoding side device may be configured to perform the steps of the method according to the second aspect.

According to a tenth aspect, a chip is provided. The chip includes a processor and a communication interface, the communication interface is coupled to the processor, and the processor is configured to run a program or an instruction, to implement the steps of the method according to the first aspect or the steps of the method according to the second aspect.

According to an eleventh aspect, a computer program/program product is provided, where the computer program/program product is stored in a storage medium, and the program/program product is executed by at least one processor to implement the steps of the method according to the first aspect or the steps of the method according to the second aspect.

In the embodiments of this application, an encoding side obtains attribute information of a first node in a first point cloud frame; and the encoding side determines, when it is determined that a second node in a second point cloud frame is similar to the first node, reconstructed attribute information of the second node based on the attribute information of the first node in the first point cloud frame.

### BRIEF DESCRIPTION OF DRAWINGS

FIG. 1 is a schematic diagram of a structure of a codec system to which this application can be applied;

FIG. 2a is an encoding flowchart executed by an encoder based on an AVS-PCC encoding framework;

FIG. 2b is an encoding flowchart executed by an encoder based on an MPEG G-PCC encoding framework;

FIG. 3a is a decoding flowchart executed by a decoder based on an AVS-PCC decoding framework;

FIG. 3b is a decoding flowchart executed by a decoder based on an MPEG G-PCC decoding framework;

FIG. 4 is a flowchart of a method for determining point cloud attribute information according to an embodiment of this application;

FIG. 5 is a schematic diagram of a nearest neighbor node;

FIG. 6 is a schematic diagram of a structure of an N-level RAHT tree constructed based on a second point cloud;

FIG. 7 is a schematic diagram of a structure obtained after an M-level RAHT tree constructed based on a first point set is added to an N-level RAHT tree constructed based on a second point cloud;

FIG. 8 is a flowchart of another method for determining point cloud attribute information according to an embodiment of this application;

FIG. 9 is a schematic diagram of a structure of an apparatus for determining point cloud attribute information according to an embodiment of this application;

FIG. 10 is a schematic diagram of a structure of another apparatus for determining point cloud attribute information according to an embodiment of this application;

FIG. 11 is a schematic diagram of a structure of an electronic device according to an embodiment of this application; and

FIG. 12 is a schematic diagram of a hardware structure of an electronic device according to an embodiment of this application.

### DESCRIPTION OF EMBODIMENTS

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

Terms such as “first” and “second” in this application are used to distinguish between similar objects, and are not used to describe a specific order or sequence. It should be understood that, the terms used in such a way are interchangeable in proper circumstances, so that the embodiments of this application can be implemented in an order other than the order illustrated or described herein. Objects classified by “first” and “second” are usually of a same type, and a quantity of objects is not limited. For example, there may be one or more first objects. In addition, in this application, “or” indicates at least one of connected objects. For example, “A or B” covers three solutions, namely, solution 1: including A and not including B; solution 2: including B and not including A; and solution 3: including A and B. A character “/” generally indicates an “or” relationship between the associated objects.

Before the technical solutions provided in the embodiments of this application are described, meanings of some terms are first described.

Point cloud (Point Cloud): Point cloud refers to a group of discrete point sets which are irregularly distributed in space and express a spatial structure and surface attributes of a three-dimensional object or a three-dimensional scenario. Point clouds may be classified into different categories according to different classification standards. For example, based on an obtaining manner, the point clouds may be classified into a dense point cloud and a sparse point cloud; and for another example, based on a temporal type, the point clouds may be classified into a static point cloud and a dynamic point cloud.

Point cloud data (Point Cloud Data): Geometry coordinate information and attribute information of each point in the point cloud together constitute the point cloud data. The geometry coordinate information may also be referred to as three-dimensional position information. Geometry coordinate information of a point in the point cloud refers to spatial coordinates (x, y, z) of the point, and may include coordinate values of the point in all coordinate axis directions of a three-dimensional coordinate system, for example, a coordinate value x in an X axis direction, a coordinate value y in a Y axis direction, and a coordinate value z in a Z axis direction. Attribute information of a point in the point cloud may include at least one of the following: color information, material information, or laser reflection intensity information (also referred to as reflectivity). Generally, each point in the point cloud has same pieces of attribute information. For example, each point in the point cloud may have two types of attribute information: color information and laser reflection intensity. For another example, each point in the point cloud may have three types of attribute information: color information, material information, and laser reflection intensity information.

Point cloud compression (Point Cloud Compression, PCC): Point cloud compression refers to a process of encoding geometry coordinate information and attribute information of each point in the point cloud, to obtain a compressed code stream. Point cloud compression may include two main processes: geometry coordinate information encoding and attribute information encoding. At present, a point cloud encoding framework that may compress the point cloud may be a geometry-based point cloud compression (Geometry-based Point Cloud Compression, G-PCC) codec framework or a video point cloud compression (Video Point Cloud Compression, V-PCC) codec framework provided by a moving picture experts group (Moving Picture Experts Group, MPEG), or an AVS-PCC codec framework provided by an audio video standard (Audio Video Standard, AVS).

Point cloud decompression: Point cloud decompression refers to a process of decoding the compressed code stream obtained from point cloud compression, to reconstruct the point cloud. Specifically, it refers to a process of reconstructing geometry coordinate information and attribute information of each point in the point cloud based on a geometry bitstream and an attribute bitstream in the compressed code stream. After the compressed code stream is obtained at a decoding side, for the geometry bitstream, entropy decoding is firstly performed to obtain quantized information of each point in the point cloud, and then inverse quantization is performed to reconstruct geometry coordinate information of each point in the point cloud. For the attribute bitstream, firstly, entropy decoding is performed to obtain quantized attribute residual information or a quantized transform coefficient of each point in the point cloud; and then inverse quantization is performed on the quantized attribute residual information to obtain reconstructed residual information, inverse quantization is performed on the quantized transform coefficient to obtain a reconstructed transform coefficient, inverse transform is performed on the reconstructed transform coefficient to obtain reconstructed residual information, and the attribute information of each point in the point cloud may be reconstructed based on the reconstructed residual information of each point in the point cloud. Reconstructed attribute information of each point in the point cloud corresponds to reconstructed geometry coordinate information one by one in order, to reconstruct the point cloud.

In a point cloud coding method based on region adaptive transform in the related art, attribute information of each node in an RAHT tree needs to be calculated, which increases complexity of a point cloud coding process. This application provides a method and an apparatus for determining point cloud attribute information, and an electronic device. With the method according to this application, when attribute encoding is performed on the second node in the second point cloud frame by using the first point cloud frame as a reference frame, reconstructed attribute information of a point cloud of the current frame can be predicted by using point cloud attribute information of an encoded and reconstructed reference frame without encoding point cloud attribute information of this part, which reduces complexity of a point cloud attribute encoding process.

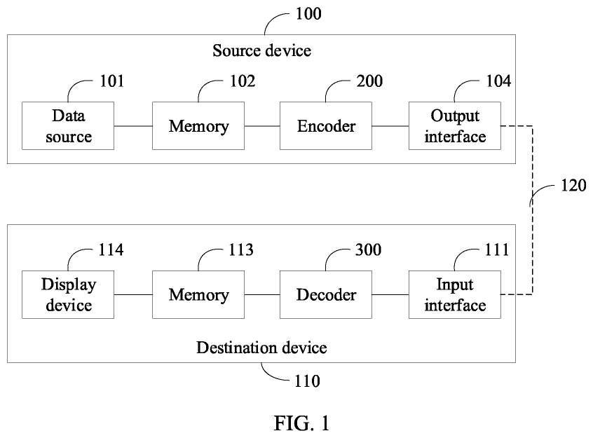

FIG. 1 is a schematic diagram of a codec system according to an embodiment of this application. The technical solutions of this embodiment of this application relate to codec (CODEC) of point cloud data (including encoding or decoding).

As shown in FIG. 1, the codec system includes a source device 100, and the source device 100 provides encoded point cloud data that is decoded and displayed by a destination device 110. Specifically, the source device 100 provides point cloud data to the destination device 110 via a communication medium 120. The source device 100 and the destination device 110 may include any one or more of the following: a desktop computer, a notebook (namely, laptop) computer, a tablet computer, a set-top box, a mobile phone, a wearable device (such as a smart watch or a wearable camera), a television, a camera, a display device, vehicle user equipment, a virtual reality (virtual reality, VR) device, an augmented reality (Augmented reality, AR) device, a mixed reality (mixed reality, MR) device, a digital media player, a video game console, a video conference device, a video streaming transmission device, a broadcast receiver device, a broadcast transmitter device, a spacecraft, an airplane, a robot, a satellite, and the like.

In the example of FIG. 1, the source device 100 includes a data source 101, a memory 102, an encoder 200, and an output interface 104. The destination device 110 includes an input interface 111, a decoder 300, a memory 113, and a display device 114. The source device 100 is an example of an encoding device, and the destination device 110 is an example of a decoding device. In other examples, the source device 100 and the destination device 110 may not include some components in FIG. 1, or may alternatively include components other than those in FIG. 1. For example, the source device 100 may obtain point cloud data through an external capture device. Similarly, the destination device 110 may be connected to an external display device interface without including an integrated display device. For another example, the memory 102 and the memory 113 may be external memories.

Although the source device 100 and the destination device 110 are depicted as separate devices in FIG. 1, in some examples, the two may be integrated in one device. In such embodiments, same hardware or software, or separate hardware or software, or any combination thereof may be used to implement a function corresponding to the source device 100 and a function corresponding to the destination device 110.

In some examples, the source device 100 and the destination device 110 may perform unidirectional data transmission or bidirectional data transmission. In a case of bidirectional data transmission, the source device 100 and the destination device 110 may operate in a substantially symmetrical manner, that is, each of the source device 100 and the destination device 110 includes an encoder and a decoder.

The data source 101 represents a source of point cloud data (namely, original and uncoded point cloud data) and provides the encoder 200 with the point cloud data, and the encoder 103 encodes the point cloud data. The source device 100 may include a capture device (such as a camera device, a sensing device, or a scanning device), an archive including previously captured point cloud data, or a feeder interface for receiving point cloud data from a data content provider. The camera device may include an ordinary camera, a stereo camera, a light field camera, or the like. The sensing device may include a laser device, a radar device, or the like. The scanning device may include a three-dimensional laser scanning device or the like. Point cloud data may be obtained by collecting real-world visual scenes through the capture device. Alternatively, the data source 101 may generate data based on computer graphics as source data, or combine real-time data, archived data, and computer-generated data. For example, the data source generates point cloud data based on a virtual object (such as a virtual three-dimensional object and a virtual three-dimensional scene obtained through three-dimensional modeling).

The encoder 200 encodes captured, pre-captured, or computer-generated data. The encoder 200 may rearrange the point cloud data from a receiving order (sometimes referred to as “display order”) in an encoding order. The encoder 200 may generate a bitstream including encoded point cloud data. The source device 100 may then output the encoded point cloud data onto the communication medium 120 via the output interface 104 for reception or retrieval by, for example, the input interface 111 of the destination device 110.

The memory 102 of the source device 100 and the memory 113 of the destination device 110 represent general-purpose memory. In some examples, the memory 102 may store original data from the data source 101, and the memory 113 may store decoded point cloud data from the decoder 300. Additionally or alternatively, the memory 102 and the memory 113 may respectively store software instructions that can be executed by, for example, the encoder 200 and the decoder 300. Although the memory 102 and the memory 113 are shown separately from the encoder 200 and the decoder 300 in this example, it should be understood that the encoder 200 and the decoder 300 may further include internal memories for functionally similar or equivalent purposes. If the encoder 200 and the decoder 300 are deployed on a same hardware device, the memory 102 and the memory 113 may be the same memory. In addition, the memory 102 and the memory 113 may store, for example, encoded point cloud data that is output from the encoder 200 and is input to the decoder 300. In some examples, portions of the memory 102 and the memory 113 may be allocated as one or more point cloud buffers, for example, for storing original, decoded, or encoded point cloud data.

In some examples, the source device 100 may output encoded data from the output interface 104 to the memory 113. Similarly, the destination device 110 may access encoded data from the memory 113 via the input interface 111. The memory 113 or the memory 102 may include any of various distributed or locally accessed data storage media, such as a hard drive, a blue-ray disc, a digital versatile disc (Digital Versatile Disc, DVD), a compact disc read-only memory (Compact Disc Read-Only Memory, CD-ROM), a flash memory, a volatile or non-volatile memory, or any other suitable digital storage media for storing encoded point cloud data.

The output interface 104 may include any type of medium or device capable of transmitting encoded point cloud data from the source device 100 to the destination device 110. For example, the output interface 104 may include a transmitter or transceiver, such as an antenna, configured to transmit encoded point cloud data directly from the source device 100 to the destination device 110 in real time. The encoded point cloud data may be modulated according to a communication standard of a wireless communication protocol, and transmitted to the destination device 110.

The communication medium 120 may include an instantaneous medium such as wireless broadcast or wired network transmission. For example, the communication medium 120 may include a radio frequency (radio frequency, RF) spectrum or one or more physical transmission lines (for example, cables). The communication medium 120 may form a part of a packet-based network (for example, a local area network, a wide area network, or a global network such as the Internet). The communication medium 120 may also be in the form of a storage medium (for example, a non-transitory storage medium), such as a hard disk, a flash drive, a compact disk, a digital point cloud disk, a blue-ray disc, a volatile or non-volatile memory or any other suitable digital storage medium for storing encoded point cloud data.

In some implementations, the communication medium 120 may include a router, a switch, a base station, or any other device that can be used to facilitate communication from the source device 100 to the destination device 110. For example, a server (not shown) may receive encoded point cloud data from the source device 100 and provide it to the destination device 110, for example, provide it to the destination device 110 via network transmission. The server may include a web server (for example, for a website), a server configured to provide a file transfer protocol service (such as a file transfer protocol (File Transfer Protocol, FTP) or a file delivery over unidirectional transport (File Delivery Over Unidirectional Transport, FLUTE) protocol), a content delivery network (content delivery network, CDN) device, a hypertext transfer protocol (Hypertext Transfer Protocol, HTTP) server, a multimedia broadcast multicast service (Multimedia Broadcast Multicast Service, MBMS) or evolved MBMS (evolved Multimedia Broadcast Multicast Service, eMBMS) server, a network-attached storage (Network-attached storage, NAS) device, or the like. The server may implement one or more HTTP streaming protocols, such as an MPEG media transport (MPEG Media Transport, MMT) protocol, a dynamic adaptive streaming over HTTP (Dynamic Adaptive Streaming over HTTP, DASH) protocol, an HTTP live streaming (HTTP Live Streaming, HLS) protocol, or a real time streaming protocol (Real Time Streaming Protocol, RTSP).

The destination device 110 may access the encoded point cloud data from the server, for example, through a wireless channel (such as a Wi-Fi connection) or a wired connection (such as a digital subscriber line (Digital subscriber line, DSL) or a cable modem) for accessing the encoded point cloud data stored on the server.

The output interface 104 and the input interface 111 may represent a wireless transmitter/receiver, a modem, a wired networking component (for example, an Ethernet card), a wireless communication component operating according to IEEE 802.11 standards or IEEE 802.15 standards (for example, ZigBee™), Bluetooth standards, and the like, or other physical components. In an example in which the output interface 104 and the input interface 111 include wireless components, the output interface 104 and the input interface 111 may be configured to transfer data, such as the encoded point cloud data based on WIFI, Ethernet, or a cellular network (such as 4G, Long Term Evolution (Long Term Evolution, LTE), Advanced LTE, 5G, or 6G).

The technology provided in this embodiment of this application can be applied to support one or more of the following application scenarios: a machine perception point cloud, which can be used in scenarios such as an autonomous navigation system, a real-time inspection system, a geographic information system, a visual sorting robot, and a rescue and disaster relief robot; and a human eye perception point cloud, which can be used in point cloud application scenarios such as digital cultural heritage, free-view broadcasting, three-dimensional immersive communication, and three-dimensional immersive interaction.

The input interface 111 of the destination device 110 receives an encoded bitstream (bitstream) from the communication medium 120. The encoded bitstream may include a high-level syntax element and an encoded data unit (such as a sequence, a picture group, a picture, a slice, or a block), where the high-level syntax element is used to decode the encoded data unit, to obtain decoded point cloud data. The display device 114 displays the decoded point cloud data to a user. The display device 114 may include a cathode ray tube (Cathode ray tube, CRT), a liquid-crystal display (liquid-crystal display, LCD), a plasma display, an organic light-emitting diode (organic light-emitting diode, OLED) display, or other types of display devices. In some examples, the destination device 110 may not have the display device 114, for example, if the decoded point cloud data is used to determine a position of a physical object, the display device 114 may be replaced with a processor.

The encoder 200 and the decoder 300 may be implemented as one or more of various processing circuits, and the processing circuit may include a microprocessor, a digital signal processor (Digital Signal Processor, DSP), an application specific integrated circuit (Application Specific Integrated Circuit, ASIC), a field programmable gate array (Field Programmable Gate Array, FPGA), discrete logic hardware, or any combination thereof. When the technology is fully or partially implemented in software, the device may store an instruction for the software in an appropriate non-transient computer-readable storage medium, and use one or more processors to execute the instruction in hardware to execute the technology provided in this embodiment of this application.

Basic principles of the encoder 200 and the decoder 300 provided in this embodiment of this application are described below by using the G-PCC codec framework and the AVS-PCC codec framework as examples.

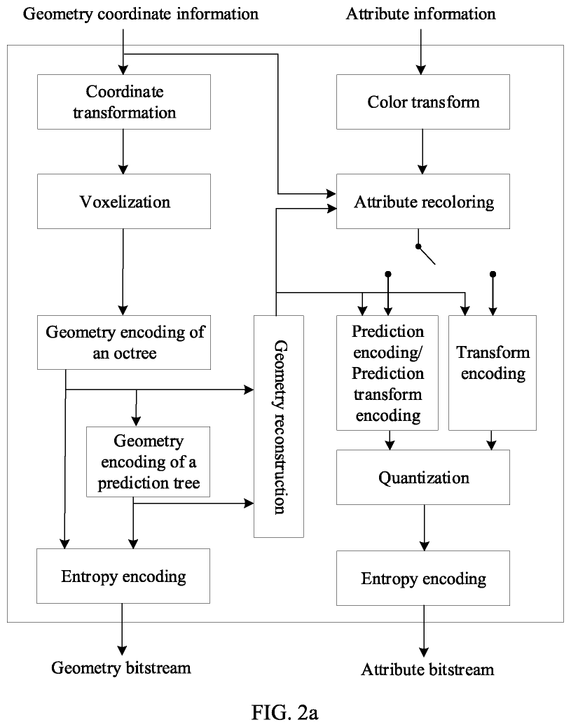

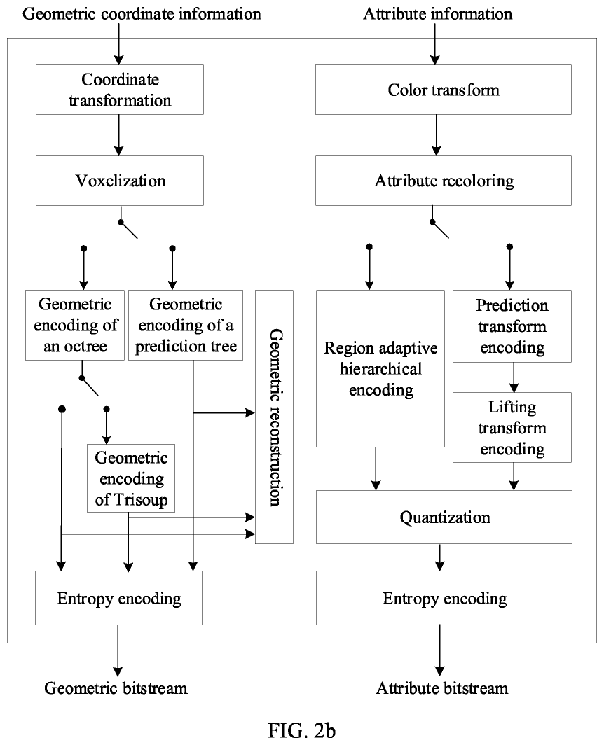

The G-PCC codec framework and the AVS-PCC codec framework are basically the same. FIG. 2a is an encoding flowchart executed by an encoder based on an AVS-PCC encoding framework, FIG. 2b is an encoding flowchart executed by an encoder based on an MPEG G-PCC encoding framework, and the encoder may be the encoder 200 shown in FIG. 1. The encoding framework can be generally divided into a geometry coordinate information encoding process and an attribute information encoding process. In the geometry information encoding process, geometry coordinate information of each point in the point cloud is encoded to obtain a geometry bitstream; in the attribute information encoding process, attribute information of each point in the point cloud is encoded to obtain an attribute bitstream; and the geometry bitstream and the attribute bitstream together form the compressed code stream of the point cloud.

For the geometry information encoding process, an encoding flow executed by the encoder 200 is as follows.

1. Pre-processing (Pre-Processing): It may include transform coordinates (Transform Coordinates) and Voxelize (Voxelize). Through scaling and translation operations, the pre-processing is to convert point cloud data in three-dimensional space into integer form, and move a minimum geometry position of the point cloud data to the origin of coordinates. In some examples, the encoder 200 may not perform pre-processing.

2. Geometry encoding: For the AVS-PCC encoding framework, the geometry encoding includes two modes: geometry encoding based on an octree (Octree) and geometry encoding based on a prediction tree. For the G-PCC encoding framework, the geometry encoding includes three modes: geometry encoding based on an octree, geometry encoding based on Trisoup (Trisoup), and prediction encoding based on a prediction tree. Where:

Geometry encoding based on octree: The octree is a tree data structure. In three-dimensional space division, a preset bounding box (bounding box) is evenly divided, and each node has eight child nodes. An occupancy state of each child node of the octree is indicated by using “1” and “0”, and occupancy code information (Occupancy Code) is obtained as the code stream of the point cloud geometry information.

Geometry encoding based on a prediction tree: Generate the prediction tree by using a prediction strategy, traverse each node from a root node of the prediction tree, and encode a residual coordinate value corresponding to each traversed node.

Geometry encoding based on Trisoup: Divide the point cloud into blocks (block) with a certain size, and locate intersection points of a point cloud surface at edges of the blocks (referred to as vertices). Compression of geometry information is achieved by encoding whether there is an intersection point on each side of the encoding block and a position of the intersection point.

3. Geometry entropy encoding (Geometry Entropy Encoding): Statistical compression encoding is performed on occupancy code information of the octree, the prediction residual information of the prediction tree, and vertex information of Trisoup, and finally a binary (0 or 1) compressed code stream is output. Statistical encoding is a lossless encoding mode, which may effectively reduce a code rate needed to express a same signal. A commonly used statistical encoding mode is content adaptive binary arithmetic coding (Content Adaptive Binary Arithmetic Coding, CABAC).

4. Geometry reconstruction: Decode and reconstruct geometry information obtained after geometry encoding.

For the attribute information encoding process, an encoding flow executed by the encoder 200 is as follows.

1. Color transform: Apply transform to transform color information of attributes into different domains. For example, color information can be transformed from RGB color space to YCbCr color space.

2. Attribute recoloring (Recoloring): In a case of lossy encoding, after the geometry coordinate information is encoded, the encoding side needs to decode and reconstruct the geometry information, that is, restore geometry information of each point in the point cloud. Search for attribute information corresponding to one or more adjacent points in an original point cloud as attribute information of the reconstructed point.

In some examples, the encoder 200 may not perform color transform or attribute recoloring.

3. Attribute information processing: In AVS-PCC, attribute information processing may include three modes: prediction (Prediction) encoding, transform (Transform) encoding, and prediction and transform (Prediction&Transform) encoding. The three encoding modes may be used under different conditions.

Prediction encoding refers to determining, based on information such as a distance or spatial relationship, an adjacent point of a to-be-encoded point in encoded points as a prediction point, and calculating prediction attribute information of the to-be-encoded point based on attribute information of the prediction point according to a set criterion. A difference between real attribute information and the prediction attribute information of the to-be-encoded point is calculated as attribute residual information, and quantization, transform (optional), and entropy encoding are performed on the attribute residual information.

Transform encoding refers to grouping and transforming attribute information, and quantizing a transform coefficient by using transform methods such as discrete cosine transform (Discrete Cosine Transform, DCT) and Haar transform (Haar Transform, Haar); obtaining attribute reconstruction information through inverse quantization and inverse transform; calculating a difference between real attribute information and the attribute reconstruction information to obtain attribute residual information, and quantizing the attribute residual information; and performing entropy encoding on a quantized transform coefficient and attribute residual.

Prediction and transform encoding refers to performing transform by using the attribute residual information obtained through prediction, and performing quantization and entropy encoding on the transform coefficient.

In MPEG G-PCC, attribute information processing may include three modes: prediction transform (Prediction Transform) encoding, lifting transform (Lifting Transform) encoding, and region adaptive hierarchical transform (Region Adaptive Hierarchical Transform, RAHT) encoding. The three encoding modes can be used under different conditions.

Prediction transform encoding refers to selecting a subset of points based on a distance, dividing the point cloud into several different levels of detail (Level of Detail, LoD), and realizing multi-quality hierarchical point cloud representation from rough to fine. Bottom-up prediction can be realized between adjacent levels, that is, an adjacent point in a rough level predicts attribute information of a point introduced in a fine level, to obtain corresponding attribute residual information. A lowest-level point is encoded as reference information.

Lifting transform encoding refers to introducing a weight updating strategy of an adjacent point on the basis of LoD adjacent level prediction, and finally obtaining prediction attribute information of each point, and obtaining corresponding attribute residual information.

Region adaptive hierarchical transform encoding refers to converting a signal into a transform domain through RAHT of attribute information, which is referred to as a transform coefficient.

4. Attribute information quantization (Attribute Quantization): Fineness of quantization is usually determined by a quantization parameter. A transform coefficient or attribute residual information obtained from attribute information processing is quantized, and entropy encoding is performed on a quantized result. For example, in prediction transform encoding and lifting transform encoding, entropy encoding is performed on quantized attribute residual information; and in RAHT, entropy encoding is performed on a quantized transform coefficient.

5. Entropy encoding (Entropy Encoding): Generally, the quantized attribute residual information and/or transform coefficient are/is finally compressed by using run length coding (Run Length Coding) and arithmetic coding (Arithmetic Coding). Information such as a corresponding encoding mode and quantization parameter is also encoded by using an entropy encoder.

The encoder 200 encodes geometry coordinate information of each point in the point cloud to obtain a geometry bitstream, and encodes attribute information of each point in the point cloud to obtain an attribute bitstream. The encoder 200 may transmit the encoded geometry bitstream and attribute bitstream to the decoder 300.

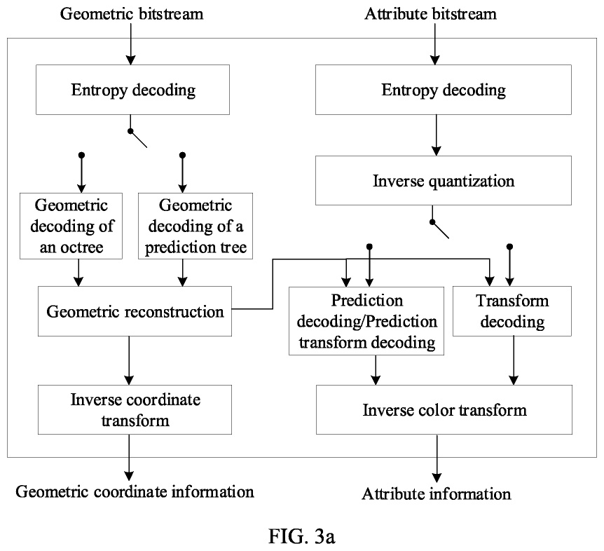

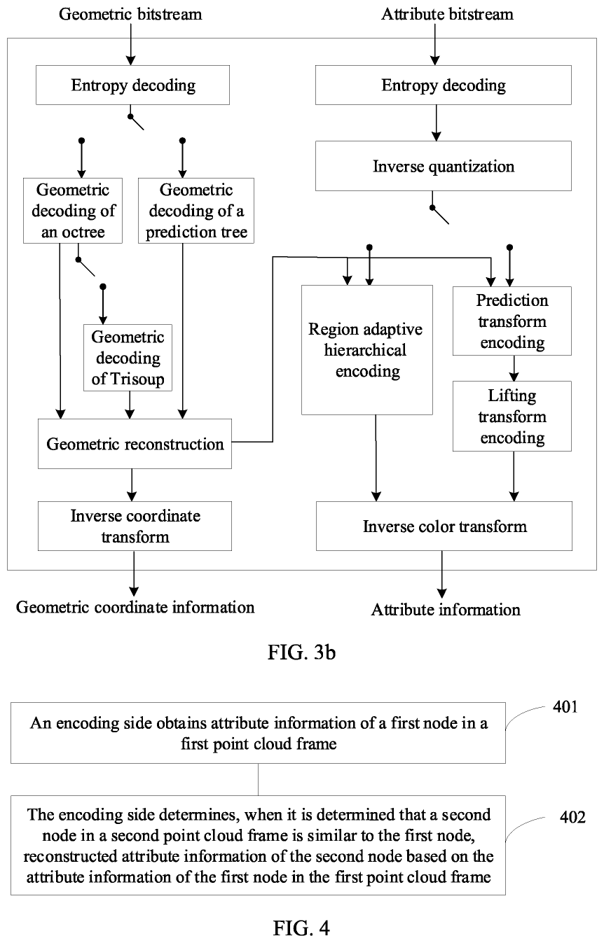

FIG. 3a is a decoding flowchart executed by a decoder based on an AVS-PCC decoding framework, FIG. 3b is a decoding flowchart executed by a decoder based on an MPEG G-PCC decoding framework, and the decoder may be the decoder 300 shown in FIG. 1. After receiving the compressed code stream (namely, the attribute bitstream and the geometry bitstream) transmitted by the encoder 200, the decoder 300 decodes the geometry bitstream to reconstruct geometry coordinate information of each point in the point cloud, and decodes the attribute bitstream to reconstruct attribute information of each point in the point cloud.

A decoding flow executed by the decoder 300 is as follows.

1. Entropy decoding (Entropy Decoding): Perform entropy decoding on the geometry bitstream and the attribute bitstream separately to obtain a geometry syntax element and an attribute syntax element.

2. Geometry decoding: For the AVS-PCC encoding framework, the geometry decoding includes two modes: geometry decoding based on an octree (Octree) and geometry decoding based on a prediction tree. For the G-PCC encoding framework, the geometry decoding includes three modes: geometry decoding based on an octree, geometry decoding based on Trisoup (Trisoup), and prediction decoding based on a prediction tree.

Geometry decoding based on an octree: Reconstruct the octree based on a geometry syntax element parsed from the geometry bitstream.

Geometry decoding based on a prediction tree: Reconstruct the prediction tree based on a geometry syntax element parsed from the geometry bitstream.

Geometry decoding based on Trisoup: Reconstruct a triangle model based on a geometry syntax element parsed from the geometry bitstream.

3. Geometry reconstruction: Perform reconstruction to obtain geometry coordinate information of points in the point cloud.

4. Inverse coordinate transform: Perform inverse transform on the reconstructed geometry coordinate information to transform reconstructed coordinates (positions) of points in the point cloud from the transform domain back to an initial domain.

5. Inverse quantization: Perform inverse quantization on the attribute syntax element.

6. Attribute information processing: In AVS-PCC, attribute information processing is used to determine color information of points in the point cloud through prediction or prediction transform on an inverse-quantized prediction residual or a prediction residual transform coefficient, or determine color information of points in the point cloud through transform on an inverse-quantized transform coefficient.

In MPEG G-PCC, attribute information processing is used to determine the color information of the points in the point cloud through RAHT on inverse-quantized attribute information, or determine the color information of the points in the point cloud through LOD and inverse lifting on inverse-quantized attribute information.

7. Inverse color transform: Transform the color information from the YCbCr color space to the RGB color space. In some examples, an inverse color transform operation may not be performed.

The embodiments of this application mainly aim at improving a point cloud G-PCC codec framework.

In the related art, attribute coding in the G-PCC codec framework may be divided into region adaptive transform based on up-sampling prediction and lifting transform based on hierarchical structure division.

1. The lifting transform based on hierarchical structure division includes: Firstly, perform hierarchical division on a to-be-encoded point cloud through level of detail (Level of Detail, LoD), to establish a hierarchical structure of the point cloud. In this process, points at a bottom level are encoded and decoded first, and therefore, points at a higher level may be predicted by using the points at the bottom level and reconstructed points at the same level, thereby achieving progressive encoding and decoding. Then, the points at the bottom level and the same level are used as reference points, the to-be-encoded point is searched for in the reference points, nearest K reference points are selected as prediction reference points, and linear interpolation prediction is performed by using reconstruction attribute values of these K nearest neighbors, where a weight is a reciprocal of a Euclidean distance between a nearest adjacent point and the to-be-encoded point. Finally, the lifting transform is performed, which includes three parts: segmentation, prediction, and update. In the segmentation stage, spatial segmentation is performed on input point cloud data, to obtain two parts: a high-level point cloud and a low-level point cloud. In the prediction stage, attribute information of the low-level point cloud is used to predict attribute information of the high-level point cloud, and a prediction residual is obtained. In a process of segmentation and prediction, because a prediction strategy in LoD division enables a point in a lower LoD level to have a higher weight, an influence weight of each point needs to be defined and recursively updated based on a prediction residual, and a distance between a prediction point and its neighbor, to finally obtain a code stream of attribute information.

2. The region adaptive transform based on up-sampling prediction includes: Firstly, construct a transform tree structure. Starting from the bottom, an octree structure is constructed from the bottom up. In a process of constructing the transform tree, corresponding Morton code information, attribute information, and weight information need to be generated for a merged node. Then, from top to bottom, up-sampling prediction and RAHT are performed level by level from a root node. If a current node is the root node, RAHT is directly performed on attribute information of the node without up-sampling prediction, and then quantization and entropy encoding are performed on a transformed direct current coefficient and alternating current coefficient, to obtain an attribute bitstream. If it is not the root node, it is determined whether to predict the current node based on a number of grandparent nodes and a number of parent nodes. If prediction is needed, for a child node of the current to-be-encoded node, a parent node of the current to-be-encoded child node, a face/edge-neighbor parent node of the current to-be-encoded child node, and a face/edge-neighbor child node of the current to-be-encoded child node are respectively selected for weighted prediction, to obtain an attribute prediction value of the current to-be-encoded child node. Then RAHT is separately performed on the attribute prediction value and an original attribute value of the current to-be-encoded node, to obtain AC coefficient residuals through calculation, and quantization and entropy encoding are performed on the AC coefficient residuals, to obtain an attribute bitstream. If no prediction is needed, RAHT is directly performed on the original attribute value of the current to-be-encoded node, and quantization and entropy encoding are performed on an obtained AC coefficient, to finally obtain an attribute code stream.

Specifically, attribute coding based on RAHT includes the following procedures.

(1) Reorder the point clouds, and construct an N-level RAHT tree by using a bottom-up construction method. A bottom level includes all nodes, and a top level is a root node level and includes only one node.

(2) Perform, based on the transform tree structure from top to bottom, up-sampling prediction and RAHT on each node level by level from a root node.

If the current node is the root node, directly perform RAHT on child node attribute information of the node without up-sampling prediction, to obtain one direct current (Direct Current, DC) coefficient and at most seven alternating current (Alternating Current, AC) coefficients.

If the current node is not the root node, it is supposed that the current node includes 2*2*2 child nodes, and it is determined whether prediction needs to be performed on a child node of the current node.

First, when the current node has only one occupied child node, no prediction is performed; and when a number of neighbor parent nodes of the current node (that is, a number of grandparent neighbors of the child node of the current node) is less than a threshold A(=2), RAHT is directly performed on original attribute information of the child node of the current node without prediction, and then quantization and entropy encoding are performed on an obtained AC coefficient; and if the number of neighbor parent nodes of the current node (that is, the number of grandparent neighbors of the child node of the current node) is greater than or equal to the threshold A, a neighbor is sought for the child node of the current node, and a neighbor search range includes: the current node, a face/edge-neighbor parent node of the child node of the current node, and a face/edge-neighbor child node of the child node of the current node.

When a number of found neighbor parent nodes is less than a threshold B(=6), RAHT is directly performed on the original attribute information of the child node of the current node without prediction, to obtain an AC transform coefficient. If the number of found neighbor parent nodes is greater than or equal to the threshold B, prediction is performed based on the neighbor node to obtain the attribute prediction value of the current child node. RAHT is separately performed on the original attribute value and the attribute prediction value, and obtained AC transform coefficients are subtracted to obtain an AC residual transform coefficient.

(3) Perform quantization and entropy encoding on the obtained transform coefficient to obtain an attribute bitstream. For the root node, quantization and entropy encoding need to be performed on both the DC transform coefficient and the AC transform coefficient; and for a node other than the root node, quantization and entropy encoding need to be performed on only the AC transform coefficient or the AC residual transform coefficient.

Up-sampling prediction is introduced into the RAHT to remove redundant information in spatial domain. Specifically, RAHT is transformed level by level from top to bottom. Therefore, when the current level is encoded, the parent node and the grandparent node of the child node of the current level, and some child nodes in the same level of the current level have been encoded, so the parent node of the current child node, the neighbor node of the parent node, and the encoded neighbor node in the same level of the current child node may be used to predict the child node of the current node. A whole process of up-sampling prediction may be divided into two steps: (1) First, perform neighbor search; and (2) Perform weighted prediction based on a found nearest neighbor.

It is worth noting that in the related art, in the process of attribute coding, only one of the region adaptive transform based on up-sampling prediction and lifting transform based on hierarchical structure division can be used to determine the transform coefficient. When the transform coefficient is determined through region adaptive transform based on up-sampling prediction, an encoding process of transform coefficients of similar nodes in the same point cloud frame may be shortened through up-sampling prediction. However, for a node with a small number of grandparent nodes and parent nodes in the current frame, a condition of up-sampling prediction is not met, so attribute coding is needed, which leads to a complex point cloud coding process. However, in the embodiments of this application, reconstructed point cloud attribute information of the reference frame may be used to predict the point cloud attribute information of the current frame, so attribute information of this part of point cloud in the current frame does not need to be encoded. Therefore, a number of points for which transform coefficients are encoded may be reduced in the attribute coding process, which effectively reduces the code rate and improves point cloud encoding efficiency.

Referring to FIG. 4, a method for determining point cloud attribute information provided in the embodiments of this application may be executed by an encoding side device. As shown in FIG. 4, the method for determining point cloud attribute information includes the following steps.

Step 401: An encoding side obtains attribute information of a first node in a first point cloud frame.

In some implementations, the first point cloud frame represents an encoded and reconstructed reference point cloud frame.

In some implementations, attribute information of a node may include attribute information of each point included in the node.

Step 402: The encoding side determines, when it is determined that a second node in a second point cloud frame is similar to the first node, reconstructed attribute information of the second node based on the attribute information of the first node in the first point cloud frame.

In some implementations, the second point cloud frame represents a to-be-encoded point cloud frame.

It is worth mentioning that, in this embodiment of this application, in a case that the point cloud has a plurality of frames, there may be points in some regions in the encoded or reconstructed reference point cloud frame similar to points in some regions in a current to-be-encoded point cloud frame. In a case that attribute information of the region has been encoded in the reference point cloud frame, attribute information of a corresponding region of the current frame may be determined based on the attribute information of the region in the reference point cloud frame, and there is no need to perform attribute encoding on the corresponding region of the current frame.

In some implementations, the determining reconstructed attribute information of the second node based on the attribute information of the first node in the first point cloud frame may be predicting attribute information of the second node based on the attribute information of the first node in the first point cloud frame, or based on the attribute information of the first node in the first point cloud frame and attribute information of an adjacent node of the first node in the first point cloud frame, and reconstructing the attribute information of the second node based on a prediction result.

In some implementations, the adjacent node of the first node in the first point cloud frame may include at least one of the following:
a face-neighbor node of the first node in the first point cloud frame;
an edge-neighbor node of the first node in the first point cloud frame;
a vertex-neighbor node of the first node in the first point cloud frame;
a child node of the first node in the first point cloud frame;
a face-neighbor node of the child node of the first node in the first point cloud frame;
an edge-neighbor node of the child node of the first node in the first point cloud frame; or
a vertex-neighbor node of the child node of the first node in the first point cloud frame.

In some other implementations, the determining reconstructed attribute information of the second node based on the attribute information of the first node in the first point cloud frame may be generating the attribute information of the second node based on the attribute information of the first node in the first point cloud frame.

In some implementations, the method further includes:
determining, by the encoding side, that the second node is similar to the first node when it is determined that the second node and the first node meet at least one of the following conditions:
a rate distortion cost of the second node determined based on the reconstructed attribute information is less than or equal to a first threshold; or
a difference between a centroid offset of the first node and a centroid offset of the second node is less than or equal to a second threshold.

In some implementations, whether a node in the second point cloud frame has a similar first node in the first point cloud frame may be indicated by using indication information (such as flag). For example, when flag=1, it indicates that the corresponding node has a similar first node in the first point cloud frame, and in this case, attribute encoding may not be performed on the node, that is, attribute encoding of the node is skipped (skip); and when flag=0, it indicates that the corresponding node has no similar first node in the first point cloud frame, and in this case, attribute encoding needs to be performed on the node.

In an implementation, when the rate distortion cost of the second node determined based on the reconstructed attribute information is less than or equal to the first threshold, rate distortion optimization (Rate Distortion Optimization, RDO) may be used to calculate a code rate and a distortion rate of the second node corresponding to the reconstructed attribute information, and calculate a rate distortion cost of the code rate and the distortion rate, which is recorded as cost. A smaller cost indicates that the code rate and the distortion rate of the second node are closer to an optimal combination, and when cost is less than or equal to the first threshold, it indicates that the reconstructed attribute information is applicable to the second node.

Optionally, when cost is greater than the first threshold, flag of the second node=0; and otherwise, flag of the second node=1.

Optionally, the first threshold may be that a code rate and a distortion rate of the second node are calculated based on a conventional technology (non-RDO), and a rate distortion cost corresponding to the code rate and the distortion rate is used as the first threshold. In other words, when cost A corresponding to a code rate and a distortion rate of the second node that are calculated through RDO is less than or equal to cost B corresponding to a code rate and a distortion rate of the second node that are calculated by using a conventional method, it can be considered that the reconstructed attribute information is applicable to the second node, and therefore, it is considered that the first node and the second node are similar.

Certainly, the first threshold may also be set by a user or associated with a point cloud service, which is not specifically limited herein.

In another implementation, if the difference between the centroid offset of the first node and the centroid offset of the second node is less than or equal to the second threshold, and flag corresponding to the second node=1, skip attribute encoding of the second node; and if the difference between the centroid offset of the first node and the centroid offset of the second node is greater than the second threshold, and flag corresponding to the second node=0, not skip attribute encoding of the second node.

It should be noted that because the centroid is calculated based on distribution of points in the node, a smaller difference of the centroid offset between the first node and the second node indicates more similar distribution of points in the two nodes, and a similarity between the first node and the second node is higher.

Optionally, the second threshold may also be set by a user or associated with a point cloud service, which is not specifically limited herein.

Optionally, the second threshold may be equal to 0. In this case, if the centroid offset of the first node is equal to the centroid offset of the second node, flag corresponding to the second node=1, skip attribute encoding of the second node; and otherwise, flag corresponding to the second node=0, not skip attribute encoding of the second node.

Optionally, if the centroid offset of the first node is equal to the centroid offset of the second node, the centroid offset of the first node in the first point cloud frame may be directly used as the centroid offset of the second node without encoding the centroid offset of the second node in a geometry encoding process; and if the centroid offset of the first node is not equal to the centroid offset of the second node, the centroid offset of the current node is still encoded in the geometry encoding process.

In some implementations, the encoding side may further obtain geometry information of the first node.

Optionally, based on geometry information of at least one node in the first point cloud frame and geometry information of the second node, a search range of similar nodes of the second node in the first point cloud frame may be defined, for example, the search range of the first node is defined as nodes, in the first point cloud frame, that match a geometry position of the second node in the second point cloud frame. For example, it is determined based on the centroid offset whether the first node and the second node are similar nodes.

Optionally, the adjacent node of the first node in the first point cloud frame may be found based on geometry information of at least one node in the first point cloud frame, and the attribute information of the second node is predicted based on the attribute information of the first node and the attribute information of the adjacent node of the first node in the first point cloud frame.

In an optional implementation, the determining reconstructed attribute information of the second node based on the attribute information of the first node in the first point cloud frame includes:
determining the reconstructed attribute information of the second node based on the attribute information of the first node in the first point cloud frame and attribute information of an adjacent node of the first node in the first point cloud frame.

In some implementations, an attribute prediction value of a point included in the second node may be determined by using attribute information of a point included in the first node and attribute information of a point included in the adjacent node of the first node in the first point cloud frame in ways such as averaging and distance-weighted averaging. The attribute prediction value is reconstructed attribute information of the point. Thereafter, recoloring of the second node may be achieved based on reconstructed attribute information of all points of the second node.

In this implementation, the attribute information of the second node may be predicted based on the attribute information of the first node in the first point cloud frame and the attribute information of the adjacent node of the first node in the first point cloud frame, and the reconstructed attribute information of the second node may be determined based on the prediction result. In this case, the attribute information of the second node does not need to be calculated and encoded, which may simplify an encoding and reconstruction process of the attribute information of the second node.

In an optional implementation, the determining the reconstructed attribute information of the second node based on the attribute information of the first node in the first point cloud frame and attribute information of an adjacent node of the first node in the first point cloud frame includes:
obtaining a first point set and a second point set, where the first point set includes points included in the second node, and the second point set includes points included in the first node and points included in the adjacent node of the first node in the first point cloud frame;
determining a third point set based on the second point set, where the third point set includes K points that are closest to a target point and that are in the second point set, the target point is a point in the first point set, and K is a positive integer; and
determining an attribute prediction value of the target point based on attribute information of each point that is in the third point set in the first point cloud frame, where the attribute prediction value of the target point is reconstructed attribute information of the target point.

In some implementations, all points of the second node included in the second point cloud frame constitute the first point set.

In some implementations, the number of the second nodes may be one or at least two.

Optionally, all points included in the second node are placed in the same first point set. Correspondingly, all points included in the first node and points included in the adjacent node of the first node in the first point cloud frame are placed in the same second point set.

Optionally, in a process of determining the third point set based on the second point set, a target point in a first point set may be matched with a point in the same second point set, to find K points closest to the target point from the second point set to form the third point set.

In this way, a number of the first point sets, the second point sets, and the third point sets may be reduced, and complexity of data management may be reduced.

Alternatively, the second node is in a one-to-one correspondence with the first point set, and points included in each second node are placed in a corresponding first point set. Correspondingly, the second point set is in a one-to-one correspondence with the second node, that is, points included in a first node similar to the second node and points included in an adjacent node of the first node in the first point cloud frame are placed in the second point set corresponding to the second node.

Optionally, in the process of determining the third point set based on the second point set, a target point in each first point set needs to be matched with a point in a second point set corresponding to the same second node, to find K points closest to the target point from the second point set to form the third point set. In other words, if there are X second nodes, numbers of the first point sets, the second point sets, and the third point sets are X respectively.

In this way, in the process of determining the third point set based on the second point set, only the second point set and the third point set corresponding to the same second node need to be found for matching, so that a number of matching points may be reduced, thereby improving efficiency of determining the third point set.

It is worth mentioning that, one second node may include a plurality of points. In this case, the target point may be each point in the second node, and the third point set is in a one-to-one correspondence with points in the second node.

For example, it is assumed that the first point set is point set A, and the second point set is point set B; K nearest neighbors of each point in point set A may be found from point set B to form a set Cᵢ, where Cᵢ represents a nearest neighbor set of an i^{th} point of point set A in point set B; and finally, based on a nearest neighbor set Cᵢ of each point in point set A, an attribute prediction value of each point may be obtained through averaging or distance-weighted averaging, and the attribute prediction value is used as reconstructed attribute information of the point.

In some implementations, the K points closest to the target point in the second point set may be determined in ways such as Manhattan distance or Euclidean distance. For example, a Euclidean distance value between the target point and each point in the second point set is calculated, and K points with smallest Euclidean distance values in the second point set are selected as the K points closest to the target point.

In some implementations, the determining an attribute prediction value of the target point based on attribute information of each point that is in the third point set in the first point cloud frame may be calculating an attribute value of each point of the third point set in the first point cloud frame in ways such as averaging or distance-weighted averaging, to obtain the attribute prediction value of the target point.

For example, a Euclidean distance value between the target point and each point in the second point set is first calculated; then based on the Euclidean distance value, respective weights of K points in the third point set are determined, for example, a smaller Euclidean distance value indicates a greater weight; and finally, based on the respective weights of the K points in the third point set, attribute values of the K points are weighted and averaged, to obtain the attribute prediction value of the target point.

In this implementation, the attribute information of the target point may be predicted based on attribute information of K points closest to the target point in the second point set, and the reconstructed attribute information of the target point is determined based on a prediction result. Thereafter, recoloring of the second node may further be achieved based on reconstructed attribute information of each point included in the second node.

It is worth noting that, after the reconstructed attribute information of the second node is determined through the above process, for other nodes, in the second point cloud frame, that do not find similar nodes in the first point cloud frame, attribute encoding may be performed in other ways, or attribute encoding is performed by other encoder devices.

In an optional implementation, the method further includes:
removing, by the encoding side, the first point set from a fourth point set, to obtain a fifth point set, where the first point set includes the points included in the second node, and the fourth point set includes all points in the first point cloud frame;
reordering, by the encoding side, the fifth point set, to obtain an N-level region adaptive hierarchical transform (RAHT) tree, where N is a positive integer;
performing, by the encoding side based on the N-level RAHT tree, up-sampling prediction and RAHT on a third node in the N-level RAHT tree level by level in an order from top to bottom, to obtain a first transform coefficient of the third node; and
determining, by the encoding side, reconstructed attribute information of a child node of the third node based on the first transform coefficient of the third node.

It should be noted that, the performing, based on the N-level RAHT tree, up-sampling prediction and RAHT on a third node in the N-level RAHT tree level by level in an order from top to bottom, to obtain a first transform coefficient of the third node, is similar to a manner in which up-sampling prediction is introduced to RAHT in the related art, to reduce spatial redundancy information, and differences include: in this embodiment of this application, a point cloud corresponding to a second node whose reconstructed attribute information is determined by using attribute information of a similar node in a reference frame is excluded from point clouds used to construct the N-level RAHT tree.

For example, the N-level RAHT tree constructed based on the second point cloud is shown in FIG. 6, while in the related art, the RAHT tree constructed based on the second point cloud frame is shown in FIG. 7. From comparison between FIG. 6 and FIG. 7, it can be seen that the up-sampling prediction and RAHT in this embodiment of this application are aimed at processing of some points connected by the solid line in FIG. 7.

In an optional implementation, the performing, by the encoding side based on the N-level RAHT tree, up-sampling prediction and RAHT on a third node in the N-level RAHT tree level by level in an order from top to bottom, to obtain a first transform coefficient of the third node may include:
determining, by the encoding side, whether up-sampling prediction needs to be performed on the third node;
performing, by the encoding side, RAHT on original attribute information of the child node of the third node when it is determined that up-sampling prediction does not need to be performed on the third node, to obtain a first alternating current (AC) transform coefficient, where the first transform coefficient includes the first AC transform coefficient; or
performing, by the encoding side, RAHT on original attribute information of the child node of the third node when it is determined that up-sampling prediction needs to be performed on the third node, to obtain a second AC transform coefficient;
determining, by the encoding side, an attribute prediction value of the child node of the third node based on up-sampling prediction;
performing, by the encoding side, RAHT on the attribute prediction value of the child node of the third node, to obtain a third AC transform coefficient; and
determining, by the encoding side, an AC residual transform coefficient based on the second AC transform coefficient and the third AC transform coefficient, where the first transform coefficient includes the AC residual transform coefficient.

The determining manner of whether up-sampling prediction needs to be performed on the third node is the same as that of up-sampling prediction in the prior art, such as determining whether it is a root node, determining whether a number of occupied child nodes is greater than a threshold, and determining whether a number of its neighbor parent nodes is greater than a threshold. Details are not described herein again.

In some implementations, if it is determined that up-sampling prediction does not need to be performed on the third node, RAHT is directly performed on the original attribute information of the child node of the third node, to obtain the first alternating current (AC) transform coefficient.

In some other implementations, if it is determined that up-sampling prediction needs to be performed on the third node, RAHT is performed on the original attribute information of the child node of the third node, to obtain the second AC transform coefficient, and RAHT is performed on the attribute prediction value of the child node of the third node, to obtain the third AC transform coefficient. Finally, the AC residual transform coefficient of the second AC transform coefficient and the third AC transform coefficient is obtained.

It is worth mentioning that the process of determining the attribute prediction value of the child node of the third node based on up-sampling prediction is similar to the up-sampling prediction process in the related art, and mainly includes two parts: part 1, searching for a neighbor of the child node of the third node from the second point cloud frame; and part 2, performing weighted prediction on attribute information of the neighbor, to obtain attribute prediction information of the child node of the third node.

Optionally, the process of searching for the neighbor of the child node of the third node from the second point cloud frame is as follows.

First, a number of grandparent neighbors of the current child node (namely, a child node of the current to-be-encoded node (the third node)) is determined. If the number of grandparent neighbors is less than threshold A(=2), RAHT is directly performed on the original attribute information without neighbor search and weighted prediction, and then quantization and entropy encoding are performed on an obtained AC coefficient, to obtain an attribute bitstream of the child node; and otherwise, nearest neighbor search is performed.

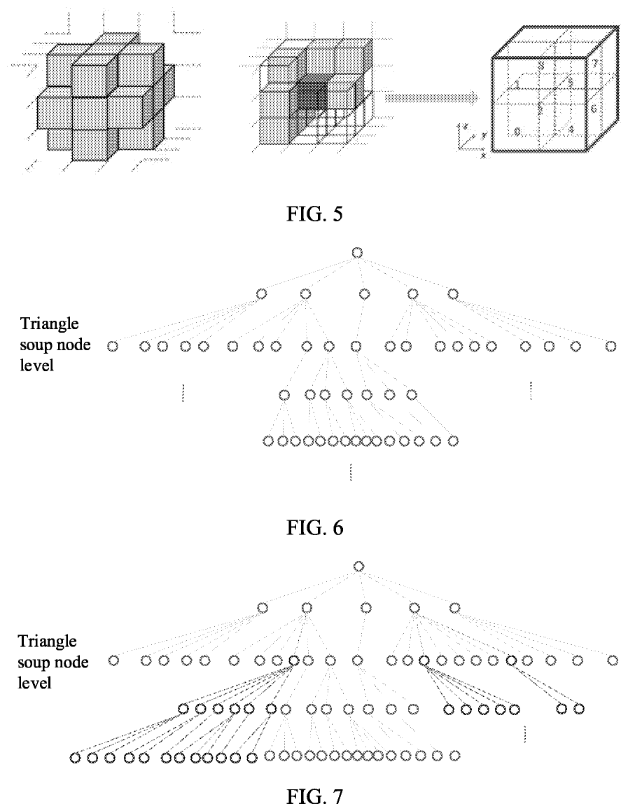

As shown in FIG. 5, when nearest neighbor search is performed, its search range is: a parent node of the current to-be-encoded child node (1), face-neighbor nodes of the parent node of the current to-be-encoded child node (6), edge-neighbor nodes of the parent node of the current to-be-encoded child node (12), face-neighbor nodes of the current to-be-encoded child node (6), and edge-neighbor nodes of the current to-be-encoded child node (12). The neighbor nodes are searched for in turn, and if the neighbor node exists, its corresponding index information is recorded.

Then, a number of neighbors of the parent node (including the parent node) is counted. If the number of neighbors of the parent node is less than threshold B(=6), RAHT is directly performed on the original attribute information of the current to-be-encoded node without weighted prediction, and then quantization and entropy encoding are performed on the obtained AC coefficient, to obtain the attribute bitstream of the child node; and otherwise, weighted prediction is performed.

Optionally, a process of performing weighted prediction on the attribute information of the neighbor node is as follows.

The nearest neighbor found in neighbor search is used to perform weighted prediction on each child node of the current to-be-encoded node. It is specified that a prediction weight of the parent node is 9, a prediction weight of a face-neighbor child node of the current to-be-encoded child node is 5, a prediction weight of an edge-neighbor child node of the current to-be-encoded child node is 2, a prediction weight of a face-neighbor parent node of the current to-be-encoded child node is 3, and a prediction weight of an edge-neighbor parent node of the current to-be-encoded child node is 1.

The parent node may be used to predict each child node of the current to-be-encoded node, and the neighbor child node may be used to predict an adjacent to-be-encoded child node, while it needs to be further determined whether other neighbor parent nodes may be used to predict the child node of the current to-be-encoded node. Determining steps are as follows.

(a) First, set two prediction thresholds based on an attribute value of the parent node to further screen nearest neighbors and filter out unreasonable points, to improve accuracy of prediction. These two thresholds are set to limitLow and limitHigh respectively, the attribute value of the parent node is set to attrPar, and the following formulas are satisfied:

$$\begin{matrix}limitLow = attrpar * 2 \\ limitHigh = attrpar * 25\end{matrix}$$

An attribute value of the current node is set to attrNei, and the following condition determination is performed on it:

$$limitLow < attrnei < limitHigh$$

(b) If the condition is not met, the current node cannot be used to predict the child node of the current to-be-encoded node; and if the condition is met, continue to perform the following determination.

Then, determine whether the current neighbor node meets a condition of sharing a face or an edge with the current to-be-encoded child node. If the condition is not met, the current neighbor node cannot be used to perform weighted prediction on the current to-be-encoded child node; and if the condition is met, the current neighbor node is used to perform weighted prediction on the current to-be-encoded child node.

Finally, each child node of the current to-be-encoded node uses a neighbor node that meets the condition as a reference point set to perform weighted prediction, to obtain an attribute prediction value of each child node of the current to-be-encoded node.

In some implementations, in view of the fact that the second point cloud for constructing the N-level RAHT tree does not include the first point set whose reconstructed attribute information has been determined through inter prediction, the first point set may be added to the N-level RAHT tree before neighbor search, to avoid a neighbor search range of the third node being limited due to deleting a node corresponding to the first point set from the N-level RAHT tree.

In some implementations, the determining, by the encoding side, reconstructed attribute information of a child node of the third node based on the first transform coefficient of the third node includes:
performing, by the encoding side, quantization and inverse quantization on the first transform coefficient of the third node to obtain a transform coefficient reconstruction value, and obtaining reconstructed attribute information of the child node of the third node through RAHT inverse transform.

In an optional implementation, before the performing, by the encoding side based on the N-level RAHT tree, up-sampling prediction and RAHT on a third node in the N-level RAHT tree level by level in an order from top to bottom, to obtain a first transform coefficient, the method further includes:
reordering, by the encoding side, the first point set, to obtain an M-level RAHT tree, where M is a positive integer; and
adding, if the encoding side determines that a target second node includes the child node of the third node when the third node is a node in a level with a size of a triangle soup (trisoup) node, the target second node to the child node of the third node in the N-level RAHT tree, where the M-level RAHT tree includes the target second node.

In some implementations, if the encoding side determines that a target second node includes the child node of the third node when the third node is a node in a level with a size of a triangle soup (trisoup) node, the target second node is added to the child node of the third node in the N-level RAHT tree.

For example, when traversing to the level with a size of a trisoup node, for each 2*2*2 node block, it is determined whether a skipped point in the first point set or a node formed by skipped points includes a child node of the 2*2*2 node block. If the child node is included, the child node is added to the child node of the current node, and may be used as neighbor information for subsequent prediction of a to-be-encoded child node in the same level and parent neighbor information for prediction of a next level of nodes.

In this implementation, the target second node in the M-level RAHT tree may be added to a corresponding position in the N-level RAHT tree, to prevent a range of neighbors that may be selected for up-sampling prediction from being limited due to a number of nodes to be encoded in the N-level RAHT tree being reduced.

In some implementations, when the encoding side and the decoding side are distributed in different devices, the encoding side may further send a target code stream of a point cloud frame to the decoding side for the decoding side to decode the target code stream, to obtain decoded data of the point cloud frame.

Optionally, the method further includes:
encoding, by the encoding side, a transform coefficient of a sixth point set of the second point cloud frame, to obtain a target code stream, where the sixth point set does not include the first point set; and
sending, by the encoding side, the target code stream to a decoding side.

In some implementations, after determining reconstructed attribute information of each node in the second point cloud frame, the encoding side may encode only a transform coefficient (such as at least one of the AC transform coefficient, the AC residual transform coefficient, and the DC coefficient) with no inter similar node in the second point cloud frame, to obtain a target code stream of the second point cloud frame.

In this way, when the decoding side may decode the target code stream, for a second node with an inter similar node, reconstructed attribute information of the second node may be predicted by using attribute information of the similar node in the reference frame, which may also reduce decoding code streams of the second node with the inter similar node at the decoding side.

In some implementations, the target code stream may specifically include a geometry bitstream and an attribute bitstream.

It should be noted that, after encoding the first point cloud frame, the encoding side may further send an encoding code stream of the first point cloud frame to the decoding side, which is not specifically limited herein.

In addition, the encoding side may further inform the decoding side of specific nodes included in the second node with the inter similar node, so that the decoding side determines reconstructed attribute information of these nodes through inter prediction.

In an optional implementation, the method further includes:
generating, by the encoding side, indication information corresponding to at least one node in the second point cloud frame, where the indication information indicates whether the corresponding node has a similar node in the first point cloud frame; and
sending, by the encoding side, the indication information to the decoding side.

In some implementations, the indication information may be carried in point cloud encoding information and sent to the decoding side together. For example, in the above embodiment, flag of each node in the second point cloud frame is added to the point cloud encoding information, if flag=1, it indicates that a corresponding node has a similar node in the first point cloud frame, and reconstructed attribute information of the node is determined through inter prediction; and if flag=0, it indicates that the corresponding node does not have a similar node in the first point cloud frame, and reconstructed attribute information of the node cannot be determined through inter prediction.

In some other implementations, the indication information is sent independently of the point cloud encoding information. For example, when sending the point cloud encoding information to the decoding side, the encoding side may further send the indication information to the decoding side separately, to indicate nodes whose reconstructed attribute information can be determined through inter prediction in the point cloud encoding information, and to indicate nodes whose reconstructed attribute information cannot be determined through inter prediction in the point cloud encoding information.

In some implementations, when determining, based on the indication information, that a second node has a similar node in the first point cloud frame, the decoding side may search the first point cloud frame for a first node similar to the second node in a manner similar to that of the encoding side. Details are not described herein again.

In this implementation, the encoding side sends indication information to the decoding side. Therefore, based on the indication information, the decoding side may perform corresponding inter prediction decoding on a node whose reconstructed attribute information is determined through inter prediction; and perform conventional decoding on a node whose reconstructed attribute information is not determined through inter prediction.

In this embodiment of this application, an encoding side obtains attribute information of a first node in a first point cloud frame; and the encoding side determines, when it is determined that a second node in a second point cloud frame is similar to the first node, reconstructed attribute information of the second node based on the attribute information of the first node in the first point cloud frame. In this way, when attribute encoding is performed on the second node in the second point cloud frame by using the first point cloud frame as a reference frame, reconstructed attribute information of a point cloud of the current frame can be predicted by using point cloud attribute information of an encoded and reconstructed reference frame without encoding point cloud attribute information of this part, which reduces complexity of a point cloud attribute encoding process.

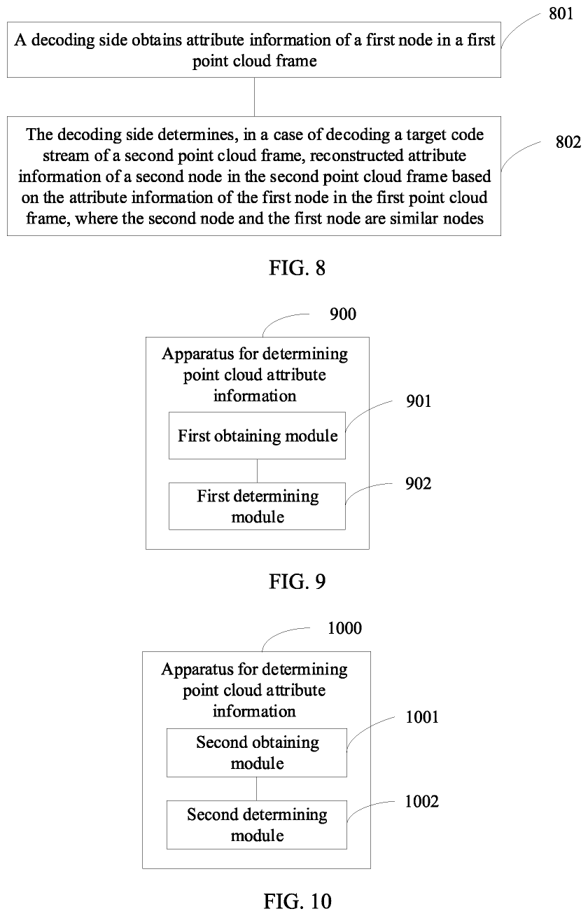

Referring to FIG. 8, another method for determining point cloud attribute information provided in the embodiments of this application may be executed by a decoding side device. As shown in FIG. 8, the method for determining point cloud attribute information includes the following steps.

Step 801: A decoding side obtains attribute information of a first node in a first point cloud frame.

Step 802: The decoding side determines, in a case of decoding a target code stream of a second point cloud frame, reconstructed attribute information of a second node in the second point cloud frame based on the attribute information of the first node in the first point cloud frame, where the second node and the first node are similar nodes.

Corresponding to the method embodiment shown in FIG. 4, in a scenario with at least two point cloud frames, the first point cloud frame is a decoded and reconstructed reference point cloud frame at the decoding side; and the second point cloud frame represents a point cloud frame of a to-be-decoded frame at the decoding side.

In addition, the first information, the attribute information of the first node in the first point cloud frame, and the reconstructed attribute information of the second node in the second point cloud frame have the same meanings as the first information, the attribute information of the first node in the first point cloud frame, and the reconstructed attribute information of the second node in the second point cloud frame in the method embodiment shown in FIG. 4. Details are not described herein again.

In this embodiment of this application, the decoding side may predict attribute information of a corresponding node in a to-be-decoded frame by using attribute information of a similar node in a reference frame through inter prediction, to achieve attribute reconstruction of the corresponding node in the to-be-decoded frame based on a prediction result.

Optionally, the method further includes:
receiving, by the decoding side, indication information, where the indication information indicates whether at least one node in the second point cloud frame has a similar node in the first point cloud frame; and
the determining, by the decoding side, reconstructed attribute information of a second node in the second point cloud frame based on the attribute information of the first node in the first point cloud frame includes:
determining, by the decoding side, the reconstructed attribute information of the second node based on the attribute information of the first node in the first point cloud frame when it is determined, based on the indication information corresponding to the second node, that there is a first node similar to the second node in the first point cloud frame.

In some implementations, the indication information may be from the encoding side device.

In some other implementations, the indication information is from other devices, such as a management device shared by the encoding side and the decoding side.

In some implementations, the decoding side may determine a similarity relationship between the second node and the first node based on the indication information, such as determining the second node first, and then determining the first node similar to the second node in the first point cloud frame.

Certainly, in addition to the above indication information, the decoding side may also learn of the similarity relationship between the second node and the first node in other ways.

For example, after obtaining to-be-decoded data, the decoding side performs entropy decoding processing on the to-be-decoded data, to obtain a transform coefficient, and performs inverse quantization processing on the transform coefficient, to obtain a first reconstruction coefficient. During decoding, flag of whether to skip attribute information of a trisoup node may further be obtained. When flag is true, it indicates that attribute information of the current trisoup node may be skipped, and first information is obtained, where the first information includes at least one of geometry information or attribute information of a node and its neighbor node in a reference frame. After that, the decoding side may find a first node similar to the current trisoup node from the reference frame based on the first information, and finally, predict the attribute information of the current trisoup node based on the attribute information of the first node.

In an optional implementation, the determining, by the decoding side, reconstructed attribute information of a second node in the second point cloud frame based on the attribute information of the first node in the first point cloud frame includes:
determining, by the decoding side, the reconstructed attribute information of the second node in the second point cloud frame based on the attribute information of the first node in the first point cloud frame and attribute information of an adjacent node of the first node in the first point cloud frame.

Optionally, the determining, by the decoding side, the reconstructed attribute information of the second node in the second point cloud frame based on the attribute information of the first node in the first point cloud frame and attribute information of an adjacent node of the first node in the first point cloud frame includes:
obtaining, by the decoding side, a first point set and a second point set, where the first point set includes points included in the second node, and the second point set includes points included in the first node and points included in the adjacent node of the first node in the first point cloud frame;
determining, by the decoding side, a third point set based on the second point set, where the third point set includes K points that are closest to a target point and that are in the second point set, the target point is a point in the first point set, and K is a positive integer; and
determining, by the decoding side, an attribute prediction value of the target point based on attribute information of each point that is in the third point set in the first point cloud frame, where the attribute prediction value of the target point is reconstructed attribute information of the target point.

In some implementations, the process in which the decoding side determines the reconstructed attribute information of the second node in the second point cloud frame based on the attribute information of the first node in the first point cloud frame and attribute information of an adjacent node of the first node in the first point cloud frame is the same as the process in which the encoding side determines the reconstructed attribute information of the second node in the second point cloud frame based on the attribute information of the first node in the first point cloud frame and attribute information of an adjacent node of the first node in the first point cloud frame. Details are not described herein again.

Corresponding to the encoding side, after geometry decoding is completed, other nodes in the second point cloud frame that do not have similar nodes in the reference frame need to continue to perform attribute decoding.

Optionally, in a case that the second point cloud frame further includes a third node, the method further includes:
obtaining, by the decoding side, a first reconstruction coefficient of the third node based on the target code stream;
removing, by the decoding side, the first point set from a fourth point set, to obtain a fifth point set, where the first point set includes the points included in the second node, and the fourth point set includes all points in the first point cloud frame;
reordering, by the decoding side, the fifth point set, to obtain an N-level region adaptive hierarchical transform (RAHT) tree, where N is a positive integer; and
performing, by the decoding side based on the N-level RAHT tree and the first reconstruction coefficient, up-sampling prediction and RAHT inverse transform on the third node in the N-level RAHT tree level by level in an order from top to bottom, to determine reconstructed attribute information of a child node of the third node.

In some implementations, the decoding side may perform entropy decoding processing and inverse quantization processing on the target code stream, to obtain the first reconstruction coefficient of the third node.

Optionally, the performing, by the decoding side based on the N-level RAHT tree and the first reconstruction coefficient, up-sampling prediction and RAHT inverse transform on the third node in the N-level RAHT tree level by level in an order from top to bottom, to
determine reconstructed attribute information of a child node of the third node includes: determining, by the decoding side based on the N-level RAHT tree, whether up-sampling prediction needs to be performed on the third node;
determining, by the decoding side when it is determined that up-sampling prediction does not need to be performed on the third node, an AC coefficient reconstruction value of the child node of the third node based on a first reconstruction coefficient of the child node of the third node;
performing, by the decoding side, RAHT inverse transform on the alternating current (AC) coefficient reconstruction value and a direct current (DC) coefficient of the child node of the third node, to determine the reconstructed attribute information of the child node of the third node; or
determining, by the decoding side, an attribute prediction value of the child node of the third node based on up-sampling prediction when it is determined that up-sampling prediction needs to be performed on the third node;
performing, by the decoding side, RAHT on the attribute prediction value of the child node of the third node, to obtain a fourth AC transform coefficient;
adding, by the decoding side, the fourth AC transform coefficient and an AC residual transform coefficient reconstruction value of the child node of the third node, to obtain a fifth AC transform coefficient reconstruction value, where the first reconstruction coefficient includes the AC residual transform coefficient reconstruction value; and
performing, by the decoding side, RAHT inverse transform on the fifth AC transform coefficient reconstruction value and the DC coefficient of the child node of the third node, to determine the reconstructed attribute information of the child node of the third node.

For example, that the decoding side decodes the second point cloud frame may include the following processes.

(1) Perform entropy decoding processing on to-be-decoded data (target code stream) to obtain a transform coefficient and flag, and then perform inverse quantization processing on the transform coefficient to obtain a first reconstruction coefficient.

(2) Determine a first point set based on flag obtained through decoding; and based on inter prediction, predict attribute information of a second node in a to-be-decoded second point cloud frame by using attribute information of a similar node in a decoded and reconstructed first point cloud frame, and perform attribute reconstruction on the second node based on a prediction result.

(3) Delete the first point set from points in the second point cloud frame to obtain a fifth point set, and construct an N-level RAHT tree based on a second point cloud.

(4) Determine whether up-sampling prediction needs to be performed on the third node in the N-level RAHT tree, and for a specific prediction method, refer to the up-sampling prediction method in other embodiments of this application. Details are not described herein again.

(5) If up-sampling prediction is not performed on the third node, obtain an AC coefficient reconstruction value from reconstruction values of the first reconstruction coefficient, inherit a DC coefficient from a parent node of the third node, and perform RAHT inverse transform on the AC coefficient and the DC coefficient, to obtain an attribute reconstruction value of a child node of the third node.

(6) If up-sampling prediction is performed on the third node, perform prediction based on a neighbor node of the third node in the N-level RAHT tree, to obtain an attribute prediction value of a current child node of the third node. Perform RAHT on the attribute prediction value to obtain an AC coefficient of the attribute prediction value, add the AC coefficient with an AC residual coefficient reconstruction value that is corresponding to the child node and that is found from the first reconstruction coefficient, to obtain an AC coefficient reconstruction value, where a DC coefficient of the attribute prediction value may be inherited from the parent node, and finally perform RAHT inverse transform on the AC coefficient and the DC coefficient, to obtain the attribute reconstruction value of the child node of the third node.

In some implementations, before the performing, by the decoding side based on the N-level RAHT tree and the first reconstruction coefficient, up-sampling prediction and RAHT inverse transform on the third node in the N-level RAHT tree level by level in an order from top to bottom, to determine reconstructed attribute information of a child node of the third node, the method further includes:
reordering, by the decoding side, the first point set, to obtain an M-level RAHT tree, where M is a positive integer; and
adding, if the decoding side determines that a target second node includes the child node of the third node when the third node is a node in a level with a size of a triangle soup (trisoup) node, the target second node to the child node of the third node in the N-level RAHT tree, where the M-level RAHT tree includes the target second node.

For example, when traversing to the level with a size of a trisoup node, for each 2*2*2 node block, it is determined whether a skipped point in the first point set or a node formed by skipped points has a child node of the current node block. If the child node exists, the child node is added to the child node of the current node, and may be used as neighbor information for subsequent prediction of a to-be-decoded child node in the same level and parent neighbor information for prediction of a next level of nodes.

In this implementation, in view of the fact that the second point cloud for constructing the N-level RAHT tree does not include the first point set of the second node whose reconstructed attribute information has been determined through inter prediction, the first point set may be added to the N-level RAHT tree before neighbor search, to avoid a neighbor search range of the third node being limited due to deleting a node corresponding to the first point set from the N-level RAHT tree.

In some implementations, the method further includes:
adding, by the decoding side, the first point set to a reconstructed point cloud of the second point cloud frame.

In this implementation, after traversing all levels in the N-level RAHT tree, to obtain reconstruction attribute values of all nodes in the N-level RAHT tree, the skipped points may be added to the reconstructed point cloud, to obtain complete decoded data of the second point cloud frame.

In this embodiment of this application, when the second node in the second point cloud frame is decoded by using a decoded and reconstructed first point cloud frame as a reference frame, reconstructed attribute information of a point cloud of the current frame can be predicted by using point cloud attribute information of a reference frame without decoding point cloud attribute information of this part, which reduces complexity of a point cloud attribute decoding process.

The method for determining point cloud attribute information provided in this embodiment of this application may be executed by the apparatus for determining point cloud attribute information. In this embodiment of this application, the apparatus for determining point cloud attribute information is described by using an example in which the apparatus for determining point cloud attribute information performs the method for determining point cloud attribute information.

Referring to FIG. 9, the apparatus for determining point cloud attribute information provided in this embodiment of this application may be an apparatus in an encoding side device. As shown in FIG. 9, the apparatus 900 for determining point cloud attribute information includes the following modules:
a first obtaining module 901, configured to obtain attribute information of a first node in a first point cloud frame; and
a first determining module 902, configured to determine, when it is determined that a second node in a second point cloud frame is similar to the first node, reconstructed attribute information of the second node based on the attribute information of the first node in the first point cloud frame.

Optionally, the apparatus 900 for determining point cloud attribute information further includes:
a third determining module, configured to determine that the second node is similar to the first node when it is determined that the second node and the first node meet at least one of the following conditions:
a rate distortion cost of the second node determined based on the reconstructed attribute information is less than or equal to a first threshold; or
a difference between a centroid offset of the first node and a centroid offset of the second node is less than or equal to a second threshold.

Optionally, the first determining module 902 is specifically configured to:
determine the reconstructed attribute information of the second node based on the attribute information of the first node in the first point cloud frame and attribute information of an adjacent node of the first node in the first point cloud frame.

Optionally, the first determining module 902 includes:
a first obtaining unit, configured to obtain a first point set and a second point set, where the first point set includes points included in the second node, and the second point set includes points included in the first node and points included in the adjacent node of the first node in the first point cloud frame;
a first determining unit, configured to determine a third point set based on the second point set, where the third point set includes K points that are closest to a target point and that are in the second point set, the target point is a point in the first point set, and K is a positive integer; and
a second determining unit, configured to determine an attribute prediction value of the target point based on attribute information of each point that is in the third point set in the first point cloud frame, where the attribute prediction value of the target point is reconstructed attribute information of the target point.

Optionally, the apparatus 900 for determining point cloud attribute information further includes:
a first removing module, configured to remove the first point set from a fourth point set, to obtain a fifth point set, where the first point set includes the points included in the second node, and the fourth point set includes all points in the first point cloud frame;
a first reordering module, configured to reorder the fifth point set, to obtain an N-level region adaptive hierarchical transform (RAHT) tree, where N is a positive integer;
a first processing module, configured to perform, based on the N-level RAHT tree, up-sampling prediction and RAHT on a third node in the N-level RAHT tree level by level in an order from top to bottom, to obtain a first transform coefficient of the third node; and
a fourth determining module, configured to determine reconstructed attribute information of a child node of the third node based on the first transform coefficient of the third node.

Optionally, the first processing module includes:
a first judgment unit, configured to determine whether up-sampling prediction needs to be performed on the third node;
a first processing unit, configured to perform RAHT on original attribute information of the child node of the third node when it is determined that up-sampling prediction does not need to be performed on the third node, to obtain a first alternating current (AC) transform coefficient, where the first transform coefficient includes the first AC transform coefficient; or
a second processing unit, configured to perform RAHT on original attribute information of the child node of the third node when it is determined that up-sampling prediction needs to be performed on the third node, to obtain a second AC transform coefficient;
a third determining unit, configured to determine an attribute prediction value of the child node of the third node based on up-sampling prediction;
a third processing unit, configured to perform RAHT on the attribute prediction value of the child node of the third node, to obtain a third AC transform coefficient; and
a fourth determining unit, configured to determine an AC residual transform coefficient based on the second AC transform coefficient and the third AC transform coefficient, where the first transform coefficient includes the AC residual transform coefficient.

Optionally, the apparatus 900 for determining point cloud attribute information further includes:
a second reordering module, configured to reorder the first point set, to obtain an M-level RAHT tree, where M is a positive integer; and
a first adding module, configured to add, if it is determined that a target second node includes the child node of the third node when the third node is a node in a level with a size of a triangle soup (trisoup) node, the target second node to the child node of the third node in the N-level RAHT tree, where the M-level RAHT tree includes the target second node.

Optionally, the apparatus 900 for determining point cloud attribute information further includes:
an encoding module, configured to encode a transform coefficient of a sixth point set of the second point cloud frame, to obtain a target code stream, where the sixth point set does not include the first point set; and
a first sending module, configured to send the target code stream to a decoding side.

Optionally, the apparatus 900 for determining point cloud attribute information further includes:
a first generating module, configured to generate indication information corresponding to at least one node in the second point cloud frame, where the indication information indicates whether the corresponding node has a similar node in the first point cloud frame; and
a second sending module, configured to send the indication information to the decoding side.

The apparatus 900 for determining point cloud attribute information provided in this embodiment of this application can implement the processes implemented in the method embodiment of FIG. 4, and a same technical effect is achieved. To avoid repetition, details are not described herein again.

The method for determining point cloud attribute information provided in this embodiment of this application may be executed by the apparatus for determining point cloud attribute information. In this embodiment of this application, the apparatus for determining point cloud attribute information is described by using an example in which the apparatus for determining point cloud attribute information performs the method for determining point cloud attribute information.

Referring to FIG. 10, the apparatus for determining point cloud attribute information provided in this embodiment of this application may be an apparatus in a decoding side device. As shown in FIG. 10, the apparatus 1000 for determining point cloud attribute information includes the following modules:
a second obtaining module 1001, configured to obtain attribute information of a first node in a first point cloud frame; and
a second determining module 1002, configured to determine, in a case of decoding a target code stream of a second point cloud frame, reconstructed attribute information of a second node in the second point cloud frame based on the attribute information of the first node in the first point cloud frame, where the second node and the first node are similar nodes.

Optionally, the apparatus 1000 for determining point cloud attribute information further includes:
a first receiving module, configured to receive indication information, where the indication information indicates whether at least one node in the second point cloud frame has a similar node in the first point cloud frame; and
the second determining module 1002 is specifically configured to:
in a case of decoding a target code stream of a second point cloud frame, if it is determined, based on the indication information corresponding to the second node, that there is a first node similar to the second node in the first point cloud frame, determine the reconstructed attribute information of the second node based on the attribute information of the first node in the first point cloud frame.

Optionally, the second determining module 1002 is specifically configured to:
determine the reconstructed attribute information of the second node in the second point cloud frame based on the attribute information of the first node in the first point cloud frame and attribute information of an adjacent node of the first node in the first point cloud frame.

Optionally, the second determining module 1002 includes:
a second obtaining unit, configured to obtain a first point set and a second point set, where the first point set includes points included in the second node, and the second point set includes points included in the first node and points included in the adjacent node of the first node in the first point cloud frame;
a fifth determining unit, configured to determine a third point set based on the second point set, where the third point set includes K points that are closest to a target point and that are in the second point set, the target point is a point in the first point set, and K is a positive integer; and
a sixth determining unit, configured to determine an attribute prediction value of the target point based on attribute information of each point that is in the third point set in the first point cloud frame, where the attribute prediction value of the target point is reconstructed attribute information of the target point.

Optionally, in a case that to-be-decoded data obtained by the decoding side further includes the reconstructed attribute information of the third node in the second point cloud frame, the apparatus 1000 for determining point cloud attribute information further includes:
a second processing module, configured to obtain a first reconstruction coefficient of the third node based on the target code stream;
a second removing module, configured to remove the first point set from a fourth point set, to obtain a fifth point set, where the first point set includes the points included in the second node, and the fourth point set includes all points in the first point cloud frame;
a third reordering module, configured to reorder the fifth point set, to obtain an N-level region adaptive hierarchical transform (RAHT) tree, where N is a positive integer; and
a third processing module, configured to perform, based on the N-level RAHT tree and the first reconstruction coefficient, up-sampling prediction and RAHT inverse transform on the third node in the N-level RAHT tree level by level in an order from top to bottom, to determine reconstructed attribute information of a child node of the third node.

Optionally, the third processing module includes:
a fourth processing unit, configured to determine, based on the N-level RAHT tree, whether up-sampling prediction needs to be performed on the third node;
a seventh determining unit, configured to determine, when the decoding side determines that up-sampling prediction does not need to be performed on the third node, an AC coefficient reconstruction value of the child node of the third node based on a first reconstruction coefficient of the child node of the third node;
a fifth processing unit, configured to perform RAHT inverse transform on the alternating current (AC) coefficient reconstruction value and a direct current (DC) coefficient of the child node of the third node, to determine the reconstructed attribute information of the child node of the third node; or
an eighth determining unit, configured to determine an attribute prediction value of the child node of the third node based on up-sampling prediction when it is determined that up-sampling prediction needs to be performed on the third node;
a sixth processing unit, configured to perform RAHT on the attribute prediction value of the child node of the third node, to obtain a fourth AC transform coefficient;
a seventh processing unit, configured to add the fourth AC transform coefficient and an AC residual transform coefficient reconstruction value of the child node of the third node, to obtain a fifth AC transform coefficient reconstruction value, where the first reconstruction coefficient includes the AC residual transform coefficient reconstruction value; and
an eighth processing unit, configured to perform RAHT inverse transform on the fifth AC transform coefficient reconstruction value and the DC coefficient of the child node of the third node, to determine the reconstructed attribute information of the child node of the third node.

Optionally, the apparatus 1000 for determining point cloud attribute information further includes:
a fourth reordering module, configured to reorder the first point set, to obtain an M-level RAHT tree, where M is a positive integer; and
a second adding module, configured to add, if it is determined that a target second node includes the child node of the third node when the third node is a node in a level with a size of a triangle soup (trisoup) node, the target second node to the child node of the third node in the N-level RAHT tree, where the M-level RAHT tree includes the target second node.

Optionally, the apparatus 1000 for determining point cloud attribute information further includes:
a third adding module, configured to add the first point set to a reconstructed point cloud of the second point cloud frame.

The apparatus 1000 for determining point cloud attribute information provided in this embodiment of this application can implement the processes implemented in the method embodiment of FIG. 8, and a same technical effect is achieved. To avoid repetition, details are not described herein again.

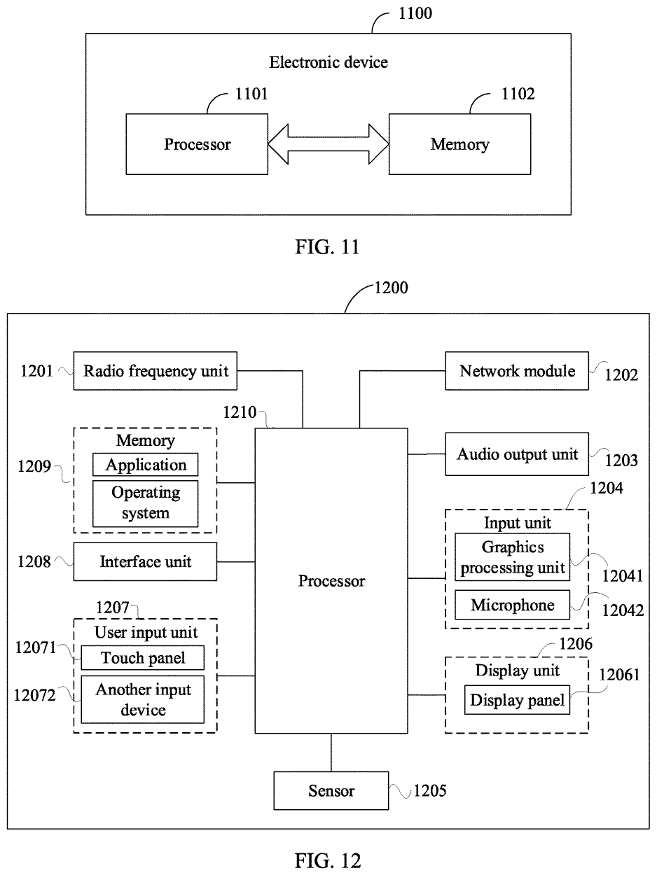

As shown in FIG. 11, an embodiment of this application further provides an electronic device 1100, including a processor 1101 and a memory 1102, and the memory 1102 stores a program or an instruction that can be run on the processor 1101. For example, in a case that the electronic device 1100 is an encoding side device, when the program or the instruction is executed by the processor 1101, the steps in the embodiment of the method for determining point cloud attribute information corresponding to the encoding side are implemented, and a same technical effect can be achieved. When the electronic device 1100 is a decoding side device, and the program or the instruction is executed by the processor 1101, the steps in the embodiment of the method for determining point cloud attribute information corresponding to the decoding side are implemented, and a same technical effect can be achieved. To avoid repetition, details are not described herein again. Optionally, the memory 1102 may be the memory 102 or the memory 113 in the embodiment shown in FIG. 1, and the processor 1101 may realize functions of the encoder 200 or the decoder 300 in the embodiment shown in FIG. 1 to FIG. 3b.

An embodiment of this application further provides an electronic device, including a processor and a communication interface. The communication interface is coupled to the processor, and the processor is configured to run a program or an instruction to implement the steps of the method embodiment shown in FIG. 4 or FIG. 8. The device embodiment is corresponding to the method embodiment, each implementation process and implementation of the method embodiment can be applied to the terminal embodiment, and a same technical effect can be achieved.

The electronic device may be a terminal, or a device other than the terminal, such as a server or a network attached storage (Network Attached Storage, NAS).

The terminal may be a terminal side device such as a mobile phone, a tablet personal computer (Tablet Personal Computer), a laptop computer (Laptop Computer), a notebook computer, a personal digital assistant (Personal Digital Assistant, PDA), a palmtop computer, a netbook, an ultra-mobile personal computer (Ultra-mobile Personal Computer, UMPC), a mobile Internet device (Mobile Internet Device, MID), an augmented reality (Augmented Reality, AR) or virtual reality (Virtual Reality, VR) device, a mixed reality (mixed reality, MR) device, a robot, a wearable device (Wearable Device), a flight vehicle (flight vehicle), vehicle user equipment (Vehicle User Equipment, VUE), ship-borne equipment, pedestrian user equipment (Pedestrian User Equipment, PUE), smart household (household devices with wireless communication functions, such as a refrigerator, a television, a washing machine, or furniture), a game console, a personal computer (Personal Computer, PC), a teller machine, or a self-service machine. The wearable device includes: a smart watch, a smart band, a smart headset, smart glasses, smart jewelry (a smart bracelet, a smart hand chain, a smart ring, a smart necklace, a smart bangle, a smart anklet, and the like), a smart wristband, smart clothing, and the like. The vehicle user equipment may also be referred to as a vehicle-mounted terminal, a vehicle-mounted controller, a vehicle-mounted module, a vehicle-mounted component, a vehicle-mounted chip, a vehicle-mounted unit, or the like. It should be noted that a specific type of the terminal is not limited in the embodiments of this application.

The server may be an independent physical server, or may be a server cluster or a distributed system including a plurality of physical servers, or may be a cloud server, and the cloud server may provide a cloud service, a cloud database, cloud computing, a cloud function, cloud storage, a network service, cloud communication, a middleware service, a domain name service, a security service, a content delivery network (Content Delivery Network, CDN), or a cloud computing service based on big data and an artificial intelligence platform.

For example, the electronic device may include, but is not limited to, the type of the source device 100 or the destination device 110 shown in FIG. 1.

In an example in which the electronic device is a terminal, FIG. 12 is a schematic diagram of a hardware structure of a terminal according to an embodiment of this application.

The terminal 1200 includes but is not limited to at least a part of components such as a radio frequency unit 1201, a network module 1202, an audio output unit 1203, an input unit 1204, a sensor 1205, a display unit 1206, a user input unit 1207, an interface unit 1208, a memory 1209, and a processor 1210.

It may be understood by a person skilled in the art that the terminal 1200 may further include a power supply (such as a battery) that supplies power to each component. The power supply may be logically connected to the processor 1210 by using a power management system, to implement functions such as charging, discharging, and power consumption management by using the power management system. The terminal structure shown in FIG. 12 constitutes no limitation on the terminal, and the terminal may include more or fewer components than those shown in the figure, or combine some components, or have different component arrangements. Details are not described herein.

It should be understood that in this embodiment of this application, the input unit 1204 may include a graphics processing unit (Graphics Processing Unit, GPU) 12041 and a microphone 12042. The graphics processing unit 12041 processes image data of a static picture or a video obtained by an image capture apparatus (for example, a camera) in a video capture mode or an image capture mode, or may process the obtained point cloud data. The display unit 1206 may include a display panel 12061, and the display panel 12061 may be configured in a form of a liquid crystal display, an organic light-emitting diode, or the like. The user input unit 1207 includes at least one of a touch panel 12071 or another input device 12072. The touch panel 12071 is also referred to as a touchscreen. The touch panel 12071 may include two parts: a touch detection apparatus and a touch controller. The another input device 12072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 1201 may transmit the downlink data to the processor 1210 for processing. In addition, the radio frequency unit 1201 may send uplink data to the network side device. Generally, the radio frequency unit 1201 includes but is not limited to an antenna, an amplifier, a transceiver, a coupler, a low noise amplifier, a duplexer, and the like.

The memory 1209 may be configured to store a software program or an instruction and various data. The memory 1209 may mainly include a first storage area for storing a program or an instruction and a second storage area for storing data. The first storage area may store an operating system, and an application or an instruction required by at least one function (for example, a sound playing function or an image playing function). In addition, the memory 1209 may include a volatile memory or a non-volatile memory. The nonvolatile memory may be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (Random Access Memory, RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synch link dynamic random access memory (Synch link DRAM, SLDRAM), and a direct rambus random access memory (Direct Rambus RAM, DRRAM). The memory 1209 in this embodiment of this application includes but is not limited to these memories and any memory of another proper type.

The processor 1210 may include one or more processing units. Optionally, an application processor and a modem processor are integrated into the processor 1210. The application processor mainly processes an operating system, a user interface, an application, and the like. The modem processor mainly processes a wireless communication signal, for example, a baseband processor. It may be understood that, alternatively, the modem processor may not be integrated into the processor 1210.

In some implementations, in a case that the terminal 1200 is used as an encoding side device, the processor 1210 is configured to:
obtain attribute information of a first node in a first point cloud frame; and
determine, when it is determined that a second node in a second point cloud frame is similar to the first node, reconstructed attribute information of the second node based on the attribute information of the first node in the first point cloud frame.

Optionally, the processor 1210 is further configured to determine that the second node is similar to the first node when it is determined that the second node and the first node meet at least one of the following conditions:
a rate distortion cost of the second node determined based on the reconstructed attribute information is less than or equal to a first threshold; or
a difference between a centroid offset of the first node and a centroid offset of the second node is less than or equal to a second threshold.

Optionally, the determining reconstructed attribute information of the second node based on the attribute information of the first node in the first point cloud frame executed by the processor 1210 includes:
determining the reconstructed attribute information of the second node based on the attribute information of the first node in the first point cloud frame and attribute information of an adjacent node of the first node in the first point cloud frame.

Optionally, the determining the reconstructed attribute information of the second node based on the attribute information of the first node in the first point cloud frame and attribute information of an adjacent node of the first node in the first point cloud frame executed by the processor 1210 includes:
obtaining a first point set and a second point set, where the first point set includes points included in the second node, and the second point set includes points included in the first node and points included in the adjacent node of the first node in the first point cloud frame;
determining a third point set based on the second point set, where the third point set includes K points that are closest to a target point and that are in the second point set, the target point is a point in the first point set, and K is a positive integer; and
determining an attribute prediction value of the target point based on attribute information of each point that is in the third point set in the first point cloud frame, where the attribute prediction value of the target point is reconstructed attribute information of the target point.

Optionally, the processor 1210 is further configured to:
remove the first point set from a fourth point set, to obtain a fifth point set, where the first point set includes the points included in the second node, and the fourth point set includes all points in the first point cloud frame;
reorder the fifth point set, to obtain an N-level region adaptive hierarchical transform (RAHT) tree, where N is a positive integer;
perform, based on the N-level RAHT tree, up-sampling prediction and RAHT on a third node in the N-level RAHT tree level by level in an order from top to bottom, to obtain a first transform coefficient of the third node; and
determine reconstructed attribute information of a child node of the third node based on the first transform coefficient of the third node.

Optionally, the performing, based on the N-level RAHT tree, up-sampling prediction and RAHT on a third node in the N-level RAHT tree level by level in an order from top to bottom, to obtain a first transform coefficient executed by the processor 1210 includes:
determining whether up-sampling prediction needs to be performed on the third node;
performing RAHT on original attribute information of the child node of the third node when it is determined that up-sampling prediction does not need to be performed on the third node, to obtain a first alternating current (AC) transform coefficient, where the first transform coefficient includes the first AC transform coefficient; or
performing RAHT on original attribute information of the child node of the third node when it is determined that up-sampling prediction needs to be performed on the third node, to obtain a second AC transform coefficient;
determining an attribute prediction value of the child node of the third node based on up-sampling prediction;
performing RAHT on the attribute prediction value of the child node of the third node, to obtain a third AC transform coefficient; and
determining an AC residual transform coefficient based on the second AC transform coefficient and the third AC transform coefficient, where the first transform coefficient includes the AC residual transform coefficient.

Optionally, before the performing, based on the N-level RAHT tree, up-sampling prediction and RAHT on a third node in the N-level RAHT tree level by level in an order from top to bottom, to obtain a first transform coefficient, the processor 1210 is further configured to:
reorder the first point set, to obtain an M-level RAHT tree, where M is a positive integer; and
add, if it is determined that a target second node includes the child node of the third node when the third node is a node in a level with a size of a triangle soup (trisoup) node, the target second node to the child node of the third node in the N-level RAHT tree, where the M-level RAHT tree includes the target second node.

Optionally, the processor 1210 is further configured to encode a transform coefficient of a sixth point set of the second point cloud frame, to obtain a target code stream, where the sixth point set does not include the first point set; and
the radio frequency unit 1201 or the network module 1202 is configured to send the target code stream to a decoding side.

Optionally, the processor 1210 is further configured to generate indication information corresponding to at least one node in the second point cloud frame, where the indication information indicates whether the corresponding node has a similar node in the first point cloud frame; and
the radio frequency unit 1201 or the network module 1202 is further configured to send the indication information to the decoding side.

In some other implementations, in a case that the terminal 1200 is used as a decoding side device, the processor 1210 is configured to:
obtain attribute information of a first node in a first point cloud frame; and
determine, in a case of decoding a target code stream of a second point cloud frame, reconstructed attribute information of a second node in the second point cloud frame based on the attribute information of the first node in the first point cloud frame, where the second node and the first node are similar nodes.

Optionally, the radio frequency unit 1201 or the network module 1202 is configured to receive indication information, where the indication information indicates whether at least one node in the second point cloud frame has a similar node in the first point cloud frame; and
the determining, in a case of decoding a target code stream of a second point cloud frame, reconstructed attribute information of a second node in the second point cloud frame based on the attribute information of the first node in the first point cloud frame executed by the processor 1210 includes:
in a case of decoding a target code stream of a second point cloud frame, if it is determined, based on the indication information corresponding to the second node, that there is a first node similar to the second node in the first point cloud frame, determining the reconstructed attribute information of the second node based on the attribute information of the first node in the first point cloud frame.

Optionally, the determining reconstructed attribute information of a second node in the second point cloud frame based on the attribute information of the first node in the first point cloud frame executed by the processor 1210 includes:
determining the reconstructed attribute information of the second node in the second point cloud frame based on the attribute information of the first node in the first point cloud frame and attribute information of an adjacent node of the first node in the first point cloud frame.

Optionally, the determining the reconstructed attribute information of the second node in the second point cloud frame based on the attribute information of the first node in the first point cloud frame and attribute information of an adjacent node of the first node in the first point cloud frame executed by the processor 1210 includes:
obtaining a first point set and a second point set, where the first point set includes points included in the second node, and the second point set includes points included in the first node and points included in the adjacent node of the first node in the first point cloud frame;
determining a third point set based on the second point set, where the third point set includes K points that are closest to a target point and that are in the second point set, the target point is a point in the first point set, and K is a positive integer; and
determining an attribute prediction value of the target point based on attribute information of each point that is in the third point set in the first point cloud frame, where the attribute prediction value of the target point is reconstructed attribute information of the target point.

Optionally, in a case that the second point cloud frame further includes a third node, the processor 1210 is further configured to:
obtain a first reconstruction coefficient of the third node based on the target code stream;
remove the first point set from a fourth point set, to obtain a fifth point set, where the first point set includes the points included in the second node, and the fourth point set includes all points in the first point cloud frame;
reorder the fifth point set, to obtain an N-level region adaptive hierarchical transform (RAHT) tree, where N is a positive integer; and
perform, based on the N-level RAHT tree and the first reconstruction coefficient, up-sampling prediction and RAHT inverse transform on the third node in the N-level RAHT tree level by level in an order from top to bottom, to determine reconstructed attribute information of a child node of the third node.

Optionally, the performing, based on the N-level RAHT tree and the first reconstruction coefficient, up-sampling prediction and RAHT inverse transform on the third node in the N-level RAHT tree level by level in an order from top to bottom, to determine reconstructed attribute information of a child node of the third node executed by the processor 1210 includes:
determining, based on the N-level RAHT tree, whether up-sampling prediction needs to be performed on the third node;
determining, when it is determined that up-sampling prediction does not need to be performed on the third node, an AC coefficient reconstruction value of the child node of the third node based on a first reconstruction coefficient of the child node of the third node;
performing RAHT inverse transform on the alternating current (AC) coefficient reconstruction value and a direct current (DC) coefficient of the child node of the third node, to determine the reconstructed attribute information of the child node of the third node; or
determining an attribute prediction value of the child node of the third node based on up-sampling prediction when it is determined that up-sampling prediction needs to be performed on the third node;
performing RAHT on the attribute prediction value of the child node of the third node, to obtain a fourth AC transform coefficient;
adding the fourth AC transform coefficient and an AC residual transform coefficient reconstruction value of the child node of the third node, to obtain a fifth AC transform coefficient reconstruction value, where the first reconstruction coefficient includes the AC residual transform coefficient reconstruction value; and
performing RAHT inverse transform on the fifth AC transform coefficient reconstruction value and the DC coefficient of the child node of the third node, to determine the reconstructed attribute information of the child node of the third node.

Optionally, before the performing, based on the N-level RAHT tree and the first reconstruction coefficient, up-sampling prediction and RAHT inverse transform on the third node in the N-level RAHT tree level by level in an order from top to bottom, to determine reconstructed attribute information of a child node of the third node, the processor 1210 is further configured to:
reorder the first point set, to obtain an M-level RAHT tree, where M is a positive integer; and
add, if it is determined that a target second node includes the child node of the third node when the third node is a node in a level with a size of a triangle soup (trisoup) node, the target second node to the child node of the third node in the N-level RAHT tree, where the M-level RAHT tree includes the target second node.

Optionally, the processor 1210 is further configured to add the first point set to a reconstructed point cloud of the second point cloud frame.

It can be understood that for the implementation process of each implementation given in this embodiment, refer to the related description of the method embodiment shown in FIG. 4 and FIG. 8, and a same or corresponding technical effect is achieved. To avoid repetition, details are not described herein again.

An embodiment of this application further provides a readable storage medium. A program or an instruction is stored in the readable storage medium. When the program or the instruction is executed by a processor, the processes of the method embodiment in FIG. 4 or FIG. 8 are implemented, and a same technical effect can be achieved. To avoid repetition, details are not described herein again.

The processor is a processor in the terminal in the foregoing embodiments. The readable storage medium includes a computer-readable storage medium, such as a ROM, a RAM, a magnetic disk, or an optical disc. In some examples, the readable storage medium may be a non-transient readable storage medium.

An embodiment of this application also provides a chip. The chip includes a processor and a communication interface. The communication interface is coupled to the processor, the processor is configured to run a program or an instruction, to implement the processes of the method embodiment shown in FIG. 4 or FIG. 8, and a same technical effect can be achieved. To avoid repetition, details are not described herein again.

It should be understood that the chip mentioned in this embodiment of this application may be a system-level chip (also referred to as a system chip, a chip system, or an on-chip system chip), an independent display chip, or the like.

An embodiment of this application also provides a computer program/program product. The computer program/program product is stored in a storage medium, the computer program/program product is executed by at least one processor to implement the processes of the method embodiment shown in FIG. 4 or FIG. 8, and a same technical effect can be achieved. To avoid repetition, details are not described herein again.

An embodiment of this application further provides a codec system, including an encoding side device and a decoding side device. The encoding side device may be configured to perform the steps of the method embodiment shown in FIG. 4, and the decoding side device may be configured to perform the steps of the method embodiment shown in FIG. 8.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the methods and apparatuses in the implementations of this application is not limited to performing functions in the order shown or discussed, but may also include performing the functions in a basically simultaneous manner or in opposite order based on the functions involved. For example, the described methods may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiment may be implemented by a computer software product and a required universal hardware platform, or certainly may be implemented by using hardware. The computer software product is stored in a storage medium (for example, a ROM, a RAM, a magnetic disk, or an optical disc), and includes several instructions for instructing a terminal or a network side device to perform the method described in the embodiments of this application.

The embodiments of this application are described above with reference to the accompanying drawings, but this application is not limited to the above specific implementations, and the above specific implementations are only illustrative and not restrictive. Under the enlightenment of this application, those of ordinary skill in the art can make many forms of implementations without departing from the purpose of this application and the protection scope of the claims, all of which fall within the protection of this application.

1. A method for determining point cloud attribute information, comprising:
obtaining, by an encoding side, attribute information of a first node in a first point cloud frame; and
determining, by the encoding side when it is determined that a second node in a second point cloud frame is similar to the first node, reconstructed attribute information of the second node based on the attribute information of the first node in the first point cloud frame.

2. The method according to claim 1, wherein the method further comprises:
determining, by the encoding side, that the second node is similar to the first node when it is determined that the second node and the first node meet at least one of the following conditions:
a rate distortion cost of the second node determined based on the reconstructed attribute information is less than or equal to a first threshold; or
a difference between a centroid offset of the first node and a centroid offset of the second node is less than or equal to a second threshold.

3. The method according to claim 1, wherein the determining reconstructed attribute information of the second node based on the attribute information of the first node in the first point cloud frame comprises:
determining the reconstructed attribute information of the second node based on the attribute information of the first node in the first point cloud frame and attribute information of an adjacent node of the first node in the first point cloud frame.

4. The method according to claim 3, wherein the determining the reconstructed attribute information of the second node based on the attribute information of the first node in the first point cloud frame and attribute information of an adjacent node of the first node in the first point cloud frame comprises:
obtaining a first point set and a second point set, wherein the first point set comprises points comprised in the second node, and the second point set comprises points comprised in the first node and points comprised in the adjacent node of the first node in the first point cloud frame;
determining a third point set based on the second point set, wherein the third point set comprises K points that are closest to a target point and that are in the second point set, the target point is a point in the first point set, and K is a positive integer; and
determining an attribute prediction value of the target point based on attribute information of each point that is in the third point set in the first point cloud frame, wherein the attribute prediction value of the target point is reconstructed attribute information of the target point.

5. The method according to claim 1, wherein the method further comprises:
removing, by the encoding side, the first point set from a fourth point set, to obtain a fifth point set, wherein the first point set comprises the points comprised in the second node, and the fourth point set comprises all points in the first point cloud frame;
reordering, by the encoding side, the fifth point set, to obtain an N-level region adaptive hierarchical transform (RAHT) tree, wherein N is a positive integer;
performing, by the encoding side based on the N-level RAHT tree, up-sampling prediction and RAHT on a third node in the N-level RAHT tree level by level in an order from top to bottom, to obtain a first transform coefficient of the third node; and
determining, by the encoding side, reconstructed attribute information of a child node of the third node based on the first transform coefficient of the third node.

6. The method according to claim 5, wherein the performing, by the encoding side based on the N-level RAHT tree, up-sampling prediction and RAHT on a third node in the N-level RAHT tree level by level in an order from top to bottom, to obtain a first transform coefficient comprises:
determining, by the encoding side, whether up-sampling prediction needs to be performed on the third node;
performing, by the encoding side, RAHT on original attribute information of the child node of the third node when it is determined that up-sampling prediction does not need to be performed on the third node, to obtain a first alternating current (AC) transform coefficient, wherein the first transform coefficient comprises the first AC transform coefficient; or
performing, by the encoding side, RAHT on original attribute information of the child node of the third node when it is determined that up-sampling prediction needs to be performed on the third node, to obtain a second AC transform coefficient;
determining, by the encoding side, an attribute prediction value of the child node of the third node based on up-sampling prediction;
performing, by the encoding side, RAHT on the attribute prediction value of the child node of the third node, to obtain a third AC transform coefficient; and
determining, by the encoding side, an AC residual transform coefficient based on the second AC transform coefficient and the third AC transform coefficient, wherein the first transform coefficient comprises the AC residual transform coefficient.

7. The method according to claim 5, wherein before the performing, by the encoding side based on the N-level RAHT tree, up-sampling prediction and RAHT on a third node in the N-level RAHT tree level by level in an order from top to bottom, to obtain a first transform coefficient, the method further comprises:
reordering, by the encoding side, the first point set, to obtain an M-level RAHT tree, wherein M is a positive integer; and
adding, if the encoding side determines that a target second node comprises the child node of the third node when the third node is a node in a level with a size of a triangle soup (trisoup) node, the target second node to the child node of the third node in the N-level RAHT tree, wherein the M-level RAHT tree comprises the target second node.

8. The method according to claim 5, wherein the method further comprises:
encoding, by the encoding side, a transform coefficient of a sixth point set of the second point cloud frame, to obtain a target code stream, wherein the sixth point set does not comprise the first point set; and
sending, by the encoding side, the target code stream to a decoding side.

9. The method according to claim 1, wherein the method further comprises:
generating, by the encoding side, indication information corresponding to at least one node in the second point cloud frame, wherein the indication information indicates whether the corresponding node has a similar node in the first point cloud frame; and
sending, by the encoding side, the indication information to the decoding side.

10. A method for determining point cloud attribute information, comprising:
obtaining, by a decoding side, attribute information of a first node in a first point cloud frame; and
determining, by the decoding side in a case of decoding a target code stream of a second point cloud frame, reconstructed attribute information of a second node in the second point cloud frame based on the attribute information of the first node in the first point cloud frame, wherein the second node and the first node are similar nodes.

11. The method according to claim 10, wherein the method further comprises:
receiving, by the decoding side, indication information, wherein the indication information indicates whether at least one node in the second point cloud frame has a similar node in the first point cloud frame; and
the determining, by the decoding side, reconstructed attribute information of a second node in the second point cloud frame based on the attribute information of the first node in the first point cloud frame comprises:
determining, by the decoding side, the reconstructed attribute information of the second node based on the attribute information of the first node in the first point cloud frame when it is determined, based on the indication information corresponding to the second node, that there is a first node similar to the second node in the first point cloud frame.

12. The method according to claim 10, wherein the determining, by the decoding side, reconstructed attribute information of a second node in the second point cloud frame based on the attribute information of the first node in the first point cloud frame comprises:
determining, by the decoding side, the reconstructed attribute information of the second node in the second point cloud frame based on the attribute information of the first node in the first point cloud frame and attribute information of an adjacent node of the first node in the first point cloud frame.

13. The method according to claim 12, wherein the determining, by the decoding side, the reconstructed attribute information of the second node in the second point cloud frame based on the attribute information of the first node in the first point cloud frame and attribute information of an adjacent node of the first node in the first point cloud frame comprises:
obtaining, by the decoding side, a first point set and a second point set, wherein the first point set comprises points comprised in the second node, and the second point set comprises points comprised in the first node and points comprised in the adjacent node of the first node in the first point cloud frame;
determining, by the decoding side, a third point set based on the second point set, wherein the third point set comprises K points that are closest to a target point and that are in the second point set, the target point is a point in the first point set, and K is a positive integer; and
determining, by the decoding side, an attribute prediction value of the target point based on attribute information of each point that is in the third point set in the first point cloud frame, wherein the attribute prediction value of the target point is reconstructed attribute information of the target point.

14. The method according to claim 10, wherein in a case that the second point cloud frame further comprises a third node, the method further comprises:
obtaining, by the decoding side, a first reconstruction coefficient of the third node based on the target code stream;
removing, by the decoding side, the first point set from a fourth point set, to obtain a fifth point set, wherein the first point set comprises the points comprised in the second node, and the fourth point set comprises all points in the first point cloud frame;
reordering, by the decoding side, the fifth point set, to obtain an N-level region adaptive hierarchical transform (RAHT) tree, wherein N is a positive integer; and
performing, by the decoding side based on the N-level RAHT tree and the first reconstruction coefficient, up-sampling prediction and RAHT inverse transform on the third node in the N-level RAHT tree level by level in an order from top to bottom, to determine reconstructed attribute information of a child node of the third node.

15. The method according to claim 14, wherein the performing, by the decoding side based on the N-level RAHT tree and the first reconstruction coefficient, up-sampling prediction and RAHT inverse transform on the third node in the N-level RAHT tree level by level in an order from top to bottom, to determine reconstructed attribute information of a child node of the third node comprises:
determining, by the decoding side based on the N-level RAHT tree, whether up-sampling prediction needs to be performed on the third node;
determining, by the decoding side when it is determined that up-sampling prediction does not need to be performed on the third node, an AC coefficient reconstruction value of the child node of the third node based on a first reconstruction coefficient of the child node of the third node;
performing, by the decoding side, RAHT inverse transform on the alternating current (AC) coefficient reconstruction value and a direct current (DC) coefficient of the child node of the third node, to determine the reconstructed attribute information of the child node of the third node; or
determining, by the decoding side, an attribute prediction value of the child node of the third node based on up-sampling prediction when it is determined that up-sampling prediction needs to be performed on the third node;
performing, by the decoding side, RAHT on the attribute prediction value of the child node of the third node, to obtain a fourth AC transform coefficient;
adding, by the decoding side, the fourth AC transform coefficient and an AC residual transform coefficient reconstruction value of the child node of the third node, to obtain a fifth AC transform coefficient reconstruction value, wherein the first reconstruction coefficient comprises the AC residual transform coefficient reconstruction value; and
performing, by the decoding side, RAHT inverse transform on the fifth AC transform coefficient reconstruction value and the DC coefficient of the child node of the third node, to determine the reconstructed attribute information of the child node of the third node.

16. The method according to claim 14, wherein before the performing, by the decoding side based on the N-level RAHT tree and the first reconstruction coefficient, up-sampling prediction and RAHT inverse transform on the third node in the N-level RAHT tree level by level in an order from top to bottom, to determine reconstructed attribute information of a child node of the third node, the method further comprises:
reordering, by the decoding side, the first point set, to obtain an M-level RAHT tree, wherein M is a positive integer; and
adding, if the decoding side determines that a target second node comprises the child node of the third node when the third node is a node in a level with a size of a triangle soup (trisoup) node, the target second node to the child node of the third node in the N-level RAHT tree, wherein the M-level RAHT tree comprises the target second node.

17. The method according to claim 14, wherein the method further comprises:
adding, by the decoding side, the first point set to a reconstructed point cloud of the second point cloud frame.

18. An electronic device, comprising a processor and a memory, wherein the memory stores a program or an instruction that can be run on the processor, and the program or the instruction is executed by the processor to implement the steps of a method for determining point cloud attribute information, wherein the method comprises:
obtaining, by an encoding side, attribute information of a first node in a first point cloud frame; and
determining, by the encoding side when it is determined that a second node in a second point cloud frame is similar to the first node, reconstructed attribute information of the second node based on the attribute information of the first node in the first point cloud frame.

19. An electronic device, comprising a processor and a memory, wherein the memory stores a program or an instruction that can be run on the processor, and the program or the instruction is executed by the processor to implement the steps of the method for determining point cloud attribute information according to claim 10.

20. A non-transitory readable storage medium, wherein the readable storage medium stores a program or an instruction, and the program or the instruction is executed by a processor to implement the steps of the method for determining point cloud attribute information according to claim 1.
